(19) United States
(12) Patent Application Publication
(10) Pub. No.: US 2024/0331394 A1
(43) Pub. Date: Oct. 3, 2024

(54) SYSTEM AND METHOD FOR TRACKING USER LOCATION TO FACILITATE SAFER MEET UPS

(71) Applicant: William Holloway Petrey, JR., Frisco, TX (US)

(72) Inventors: William Holloway Petrey, JR., Frisco, TX (US); Steven Mason, Las Vegas, NV (US)

(73) Assignee: William Holloway Petrey, JR., Frisco, TX (US)

(21) Appl. No.: 18/742,026

(22) Filed: Jun. 13, 2024

Related U.S. Application Data
(63) Continuation-in-part of application No. 18/518,136, filed on Nov. 22, 2023.
Application No. 18/518,136 is a continuation-in-part of application No. 17/688,340, filed on Mar. 7, 2022, now Pat. No. 11,915,485.
Application No. 17/688,340 is a continuation of application No. 16/910,949, filed on Jun. 24, 2020, now Pat. No. 11,270,129.
(60) Provisional application No. 62/866,278, filed on Jun. 25, 2019.
(60) Provisional application No. 63/615,148, filed on Dec. 27, 2023.

(51) Int. Cl. G06V 20/54; G06V 20/62; G06V 40/16; G08B 7/06; G08B 25/10

(52) U.S. Cl. CPC G06V 20/54; G06V 20/63; G06V 40/161; G08B 7/06; G06V 20/625; G08B 25/10

(57) ABSTRACT

A computer-implemented method includes receiving, from two users' computing devices, tracking information pertaining to locations of the two users' computing devices, determining, based on the tracking information, the locations of the two users' computing devices, and responsive to determining the locations of the two users' computing devices, providing to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface. As the proximity of the first and second locations changes, the method includes, causing the computing devices to present indications related to the proximity of the first and second locations.

### CROSS-REFERENCES TO RELATED APPLICATIONS

This application claims priority to and is a continuation-in-part of U.S. patent application Ser. No. 18/518,136 (Attorney Docket No. 85299-116) filed Nov. 22, 2023, entitled “System and Method for Predicting the Presence of an Entity at Certain Locations,” which is a continuation-in-part of U.S. patent application Ser. No. 17/688,340 (Attorney Docket No. 85299-106) filed Mar. 7, 2022, now U.S. Pat. No. 11,915,485, entitled “System and Method for Correlating Electronic Device Identifiers and Vehicle Information,” which is a continuation of U.S. patent application Ser. No. 16/910,949 (Attorney Docket No. 85299-101) filed Jun. 24, 2020, now U.S. Pat. No. 11,270,129, entitled “System and Method for Correlating Electronic Device Identifiers and Vehicle Information,” which claims priority to and the benefit of U.S. Provisional Application Ser. No. 62/866,278 (Attorney Docket No. 85299-100) filed Jun. 25, 2019, the entire disclosures of which are hereby incorporated by reference.

This application also claims priority to and is a conversion of U.S. Provisional Application Ser. No. 63/615, 148 (Attorney Docket No. 85299-112) filed Dec. 27, 2023, entitled “System and Method for Tracking User Location to Facilitate Safer Meet Ups.”

### TECHNICAL FIELD

This disclosure relates generally to information correlation. More specifically, this disclosure relates to a system and method for tracking user location to facilitate safer meet ups.

### BACKGROUND

Many public and private areas, including airports, business parks, companies, border checkpoints, neighborhoods, etc. employ measures to enhance the safety of the people and property on the area premises. For example, some neighborhoods are gated and visitors to the communities may be forced to check-in with a guard at a security gate prior to being allowed into the neighborhood. Some neighborhoods employ a crime watch group that includes a group of concerned citizens who work together with law enforcement to help keep their neighborhood safe. Such a program may rely on volunteers to patrol the neighborhood to help law enforcement discover and/or thwart suspicious and/or criminal activity. However, these and other conventional measures lack the ability to correlate certain information that provides for enhanced identification, tracking, and notification of and/or to suspicious vehicles/individuals.

Further, people may desire to meet in-person for a number of reasons. For example, people may desire to meet on a date, at a social interest or meetup group, at a work event, at a social event, at a private event, at a public event, or some combination thereof. Typically, in the dating scenario, at least two people will agree to meet at a certain location (e.g., restaurant) at a certain time and date. However, the people may not know each other very well or even at all, may not know the area surrounding the location very well or even at all, and/or may be generally nervous to meet the person in public. There is currently a lack of a mechanism for facilitating safer meetups between people at locations.

### SUMMARY

In general, the present disclosure provides a system and method for correlating wireless network information.

In one embodiment, a computer-implemented method includes receiving, from at least two users' computing devices, tracking information pertaining to locations of the at least two users' computing devices, determining, based on the tracking information, the locations of the at least two users' computing devices, responsive to determining the locations of the at least two users' computing devices, providing to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface. The method includes as a proximity of the first and second locations changes, causing the first and second users' computing devices to present indications related to the proximity of the first and second locations.

In one embodiment, a computer-implemented method includes receiving, from at least two users' computing devices, tracking information pertaining to intentions of the at least two users, determining, based on the tracking information pertaining to the intentions of the at least two users, one or more expected locations of the at least two users' computing devices, responsive to determining the one or more expected locations of the at least two users' computing devices, determining respective navigational guidance from each of the two users' computing devices to the one or more expected locations, and providing, to each of the two users' computing devices, the respective navigational guidance to enable user interfaces of the two users' computing devices to display paths that merge at the one or more expected locations.

In one embodiment, a computer-implemented method includes receiving, from one or more sources, information pertaining to a set of users, generating, based on the information, a set of scores associated with the set of users, determining a subset of the set of users who are associated with a score that satisfies a threshold score, providing, to a first computing device of a first user, one or more recommendations associated with the subset of the set of users, receiving, from the first computing device of the first user, a request to meet a second user of the subset of the set of users, receiving, from the first computing device of the first user and a second computing device of the second user, tracking information pertaining to locations of the first and second user, and determining, based on the tracking information, the locations of the first and second computing devices. Responsive to determining the locations of the first and second computing devices, the method includes determining respective navigational guidance from each of the first and second computing devices to a meeting location, and providing, to each of the first and second computing devices, the respective navigational guidance to enable user interfaces of the first and second computing devices to display paths that merge at the meeting location.

In some embodiments, one or more tangible, non-transitory computer-readable media storing instructions that, when executed, cause one or more processing devices to perform any of the methods described herein.

In some embodiments, a system may include one or more memory devices storing instructions and one or more processing devices communicatively coupled to the one or more memory devices. The one or more processing devices may execute the instructions to perform any of the methods described herein.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

It should be noted that the term “cellular media access control (MAC) address” may refer to a MAC, international mobile subscriber identity (IMSI), mobile station international subscriber directory number (MSISDN), enhanced network selection (ENS), or any other form of unique identifying number.

### BRIEF DESCRIPTION OF THE DRAWINGS

For a more complete understanding of this disclosure and its advantages, reference is now made to the following description, taken in conjunction with the accompanying drawings, in which:

FIG. 1A illustrates a high-level component diagram of an illustrative system architecture, according to certain embodiments of this disclosure;

FIG. 1B illustrates an example of trilateration using the system architecture of FIG. 1A, according to certain embodiments of the present disclosure;

FIG. 2 illustrates details pertaining to various components of the illustrative system architecture of FIG. 1A, according to certain embodiments of this disclosure;

FIG. 3 illustrates example method for monitoring vehicle traffic, according to certain embodiments of this disclosure;

FIG. 4 illustrates another example method for monitoring vehicle traffic, according to certain embodiments of this disclosure;

FIG. 5 illustrates example use interfaces presented on computing devices during monitoring vehicle traffic, according to certain embodiments of this disclosure;

FIG. 6 illustrates another high-level component diagram of an illustrative system architecture, according to certain embodiments of this disclosure;

FIG. 7A-7B illustrates an example user interfaces for enabling real-time location tracking and oversight for meet up participants, according to certain embodiments of this disclosure;

FIG. 8 illustrates an example method for enabling real-time location tracking for users participating in meet ups, according to certain embodiments of this disclosure;

FIG. 9 illustrates an example method for providing a message pertaining to whether or not users should meet, according to certain embodiments of this disclosure;

FIG. 10 illustrates an example method for transmitting, based on a risk level, a message pertaining to whether or not users should meet, according to certain embodiments of this disclosure;

FIG. 11 illustrates an example method for facilitating, based on intentions of users, navigational guidance to one or more expected meeting locations, according to certain embodiments of this disclosure;

FIG. 12 illustrates an example method for performing a preventative action when a computing device does not arrive at an expected location, according to certain embodiments of this disclosure;

FIG. 13 illustrates an example method for performing a preventative action when a computing device varies from a path, according to certain embodiments of this disclosure;

FIG. 14 illustrates an example method providing, based on one or more scores, a recommendation associated with a subset of users, according to certain embodiments of this disclosure; and

FIG. 15 illustrates an example computer system according to certain embodiments of this disclosure.

### DETAILED DESCRIPTION

Improvement is desired in the field of public safety for certain areas (e.g., neighborhood, airport, business park, border checkpoint, city, etc.). As discussed above, there are various measures that may be conventionally used, such as gated communities, neighborhood crime watch groups, and so forth. However, the conventional measures lack efficiency and accuracy in identifying suspicious vehicles/individuals and reporting of the suspicious vehicles/individuals, among other things. In some instances, the conventional measures may fail to report the suspicious vehicle/individual, altogether. The causes of the inefficient and/or failed reporting may be at least in part attributable to people (e.g., neighbors in a neighborhood) not having access to verified vehicle and/or personal information of an individual. Further, the conventional measures lack the ability to quickly, accurately, and automatically identify the vehicle as a suspicious vehicle, correlate vehicle information (e.g., license plate identifier (ID)), electronic device information (e.g., electronic device identifier (ID)), face information, etc., and/or perform a preventative action based on the identification.

Take the following example for illustrative purposes. A neighbor may witness an unknown vehicle drive through the neighborhood several times within a given time period during a day. The neighbor may not recognize the license plate ID or driver and may think about reporting the unknown vehicle to law enforcement. Instead, the neighbor may decide to proceed to do another activity. Subsequently, the person may burglarize a house in the neighborhood. Even if the neighbor attempted to lookup the license plate ID, and was able to find out information about an owner of the vehicle, the neighbor may not be able to determine whether the driver of the vehicle is the actual owner, the neighbor may not be able to determine whether the owner or driver is on a crime watch list, and so forth. Further, the neighbor may not be privy to the electronic device identifier of the electronic device the suspicious individual is carrying or that is installed in the vehicle, which may be used to track the whereabouts of the individual/vehicle in a monitored area. Even if a neighbor obtains an electronic device identifier, there currently is no technique for determining personal information associated with the electronic device identifier. To reiterate, conventional techniques for public safety lack the ability to identify a suspicious vehicle/individual and/or to correlate vehicle information, facial information, and/or electronic device identifiers of electronic devices of the driver to make an informed decision quickly, accurately, and automatically.

Aspects of the present disclosure relate to embodiments that overcome the shortcomings described above. The present disclosure relates to a system and method for correlating electronic device identifiers with vehicle information. The system may include one or more license plate detection zones, one or more electronic device detection zones, and/or one or more facial detection zones. The zones may be partially or wholly overlapping and there may be multiple zones established that span a desired area (e.g., a neighborhood, a city block, a public/private parking lot, any street, etc.). The license plate detection zones, the electronic device detection zones, and/or the facial detection zones may include devices that are communicatively coupled to one or more computing systems via a network. The license plate detection zones may include one or more cameras configured to capture images of at least license plates on vehicles that enter the license plate detection zone. The electronic device detection zone may include one or more electronic device identification sensors, such as a Wi-Fi signal detection device or a Bluetooth® signal detection device. The electronic device identification sensors may be configured to detect and store Wi-Fi Machine Access Control (MAC) addresses, Bluetooth MAC addresses, and/or cellular MAC addresses (e.g., International Mobile Subscriber Identity (IMSI), Mobile Station International Subscriber Directory Number (MSISDN), and Electronic Serial Numbers (ESN)) of electronic devices that enter the electronic device detection zone based on the signals emitted by the electronic devices. The facial detection zones may include one or more cameras configured to capture images or digital frames that are used to recognize a face. Any suitable MAC address may be detected, and to that end, a MAC address may be any combination of the IDs described herein (e.g., MAC, MSISIDN, IMSI, ESN, etc.).

The computing system may analyze the images captured by the cameras and detect a license plate identifier (ID) of a vehicle. The license plate ID may be compared with trusted license plate IDs that are stored in a database. When there is not a trusted license plate ID that matches the license plate ID, the computing system may identify the vehicle as a suspicious vehicle. Then, the computing system may correlate the license plate ID of the vehicle with at least one of the stored electronic device identifiers. In some embodiments, the license plate ID and the at least one of the stored electronic device identifiers may be correlated with a face of the individual. In some embodiments, personal information, such as name, address, Bluetooth MAC address, Wi-Fi MAC address, criminal record, whether the suspicious individual is on a crime watch list, etc. may be retrieved using the license plate ID or the at least one of the stored electronic device identifiers that is correlated with the license plate ID of the suspicious vehicle.

The system may include several computer applications that may be accessed by registered users of the system. For example, a client application may be accessed by a computing device of a user, such as a neighbor in a neighborhood implementing the system. The client application may present a user interface including an alert when a suspicious vehicle and/or individual is detected. The user interface may present several preventative actions for the user. For example, the user may contact the suspicious individual using the personal information (e.g., send a threatening text message), notify law enforcement, and so forth. Accordingly, a client application may be accessed by a computing device of a law enforcer. The client application may present a user interface including the notification that a suspicious vehicle and/or individual is detected in the particular zones.

Take the following example of a setup of the system for illustration purposes. In a neighborhood, that may only be accessed by two entrances, license plate detection zones and electronic device detection zones may be placed to cover both lanes at both entrances. In some instances, a facial detection zone may be placed at the entrances with the other zones. Each vehicle may be correlated with each electronic device that enters the neighborhood. Further, the recognized face may be correlated with the electronic device and the vehicle information. The houses inside the neighborhood may setup electronic device detection zones and/or a facial detection zone inside their property to detect electronic device IDs and/or faces and compare them with electronic device IDs and/or faces in a database that stores every correlation that has been made by the system to date (including the most recent correlations of electronic device IDs, faces, and/or vehicles entering the neighborhood). The home owner may be notified via the client application on their computing device if an electronic device and/or face is detected on their property. Further, in some embodiments, the individual associated with the electronic device and/or face may be notified on the electronic device that the homeowner is aware of their presence. If a known criminal with a warrant is detected at either the zones at the entrance or at the zones at the homeowner's property, the appropriate law enforcement agency may be notified of their whereabouts.

The disclosed techniques provide numerous benefits over conventional systems. For example, the system provides efficient, accurate, and automatic identification of suspicious vehicles and/or individuals. Further, the system enables correlating vehicle license plate IDs with electronic device identifiers to enable enhanced detection and/or preventative actions, such as directly communicating with the electronic device of the suspicious individual and/or notifying law enforcement using the client application in real-time or near real-time when the suspicious vehicle enters one or more zones. For example, once the electronic device identifier is detected, a correlation may be obtained with a license plate ID to obtain personal information about the owner that enables contacting the owner directly and/or determining whether the owner is a criminal. The client application provides pertinent information pertaining to both the suspicious vehicle and/or individual in a single user interface without the user having to perform any searches of the license plate ID or electronic device identifier. As such, in some embodiments, the disclosed techniques reduce processing, memory, and/or network resources by reducing searches that the user may perform to find the information. Also, the disclosed techniques provide an enhanced user interface that presents the suspicious vehicle and/or individual information in single location, which may improve a user's experience using the computing device.

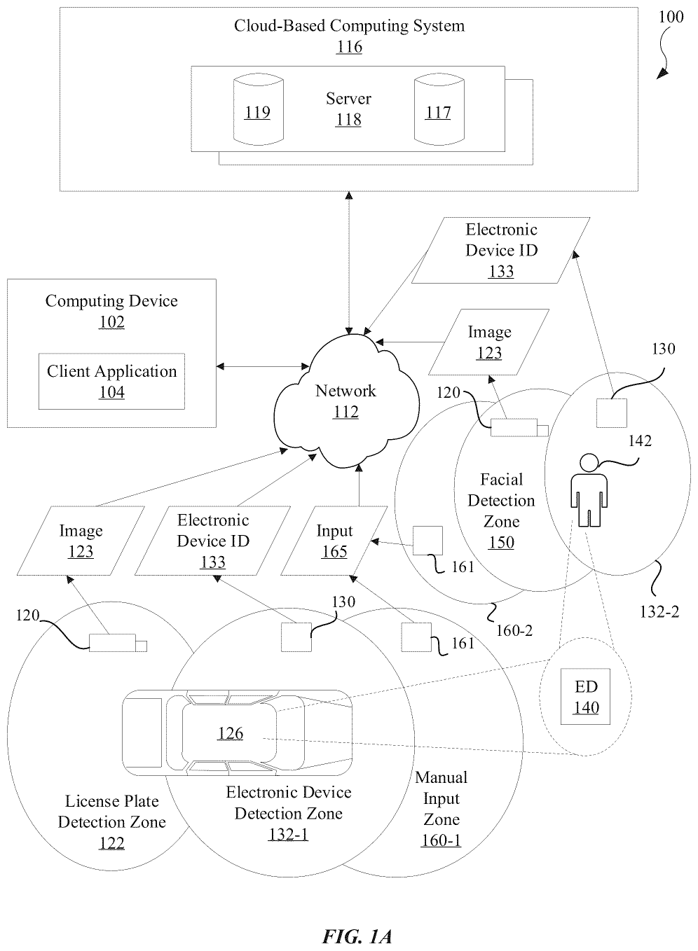

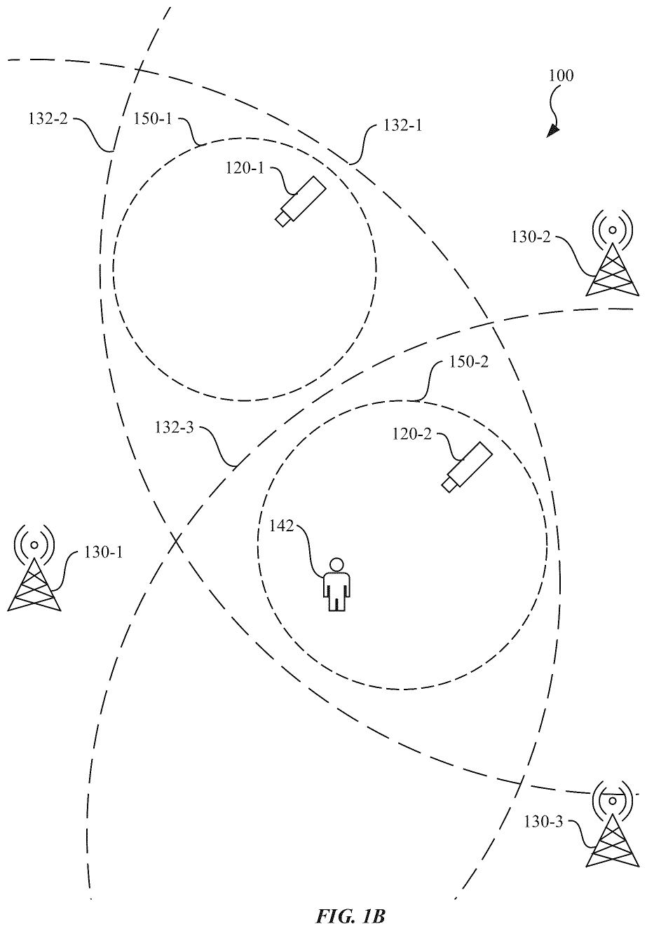

FIG. 1A illustrates a high-level component diagram of an illustrative system architecture 100 according to certain embodiments of this disclosure. In some embodiments, the system architecture 100 may include a computing device 102 communicatively coupled to a cloud-based computing system 116, one or more cameras 120, one or more electronic device identification sensors 130, and/or one or more electronic device 140 of a suspicious individual. The cloud-based computing system 116 may include one or more servers 118. Each of the computing device 102, the servers 118, the cameras 120, the electronic device identification sensors 130, and the electronic device 140 may include one or more processing devices, memory devices, and network interface devices.

The network interface devices may enable communication via a wireless protocol for transmitting data over short distances, such as Bluetooth, ZigBee, etc. Additionally, the network interface devices may enable communicating data over long distances, and in one example, the computing device 102 may communicate with a network 112. Network 112 may be a public network (e.g., connected to the Internet via wired (Ethernet) or wireless (Wi-Fi)), a private network (e.g., a local area network (LAN) or wide area network (WAN)), or a combination thereof.

The computing device 102 may be any suitable computing device, such as a laptop, tablet, smartphone, or computer. The computing device may be configured to execute a client application 104 that presents a user interface. The client application 104 may be implemented in computer instructions stored on one or more memory devices and executed by one or more processing devices of the computing device 102. The client application 104 may be a standalone application installed on the computing device 102 or may be an application that is executed by another application (e.g., a website in a web browser).

The computing device 102 may include a display that is capable of presenting the user interface of the client application 104. The user interface may present various screens to a user depending on what type of user is logged into the client application 104. For example, a user, such as a neighbor or person interested in a particular license plate detection zone 122 and/or electronic device detection zone 132, may be presented with a user interface for logging into the system where the user enters credentials (username and password), a user interface that displays alerts of suspicious vehicles and/or individuals in the zones 122 and/or 132 where the user interface includes options for preventative actions, a user interface that presents logged events over time, and so forth. For example, the client application 104 may enable the user to directly contact (e.g., send text message, send email, call) the electronic device 140 of a suspicious individual 142 using personal information obtained about the individual 142. Another user, such as a law enforcer, may be presented with a user interface for logging into the system where the user enters credentials (username and password), a user interface that displays notifications when the user selects to notify law enforcement where the notifications may include information related to the suspicious vehicle and/or individual 142.

In some embodiments, the cameras 120 may be located in the license plate detection zones 122. Although just one camera 120 and one license plate detection zone 122 are depicted, it should be noted that any suitable number of cameras 120 may be located in any suitable number of license plate detection zones 122. For example, multiple license plate detection zones 122 may be used to cover a desired area. A license plate detection zone 122 may refer to an area of coverage that is within the cameras' 120 field of view. The cameras 120 may be any suitable camera and/or video camera capable of capturing a set of images 123 that at least represent license plates of a vehicle 126 that enters the license plate detection zone 122. The set of images 123 may be transmitted by the camera 120 to the cloud-based computing system 116 and/or the computing device 102 via the network 112.

In some embodiments, the electronic device identification sensors 130 may be located in the electronic device detection zones 132. In some embodiments, the license plate detection zone 122 and the electronic device detection zone 132-1 may partially or wholly overlap. The combination of license plate detection zones 122 and the electronic device detection zones 132 may be setup at entrances/exits to certain areas, and/or any other suitable area in a monitored area, to correlate each vehicle information with respective electronic device identifiers 133 of electronic devices 140 being carried in respective vehicles 126. Each of the license plate detection zones 122 and electronic device detection zones 132 may have unique geographic identifiers so the data can be tracked by location. It should be noted that any suitable number of electronic device identification sensors 130 may be located in any suitable number of electronic device detection zones 132. For example, multiple electronic device detection zones 132 may be used to cover a desired area. An electronic device detection zone 132 may refer to an area of coverage that is within the electronic device identification sensor 130 detection area.

In one example, an electronic device detection zone 132-2 and/or a facial detection zone 150 may be setup at a home of a homeowner, such that an electronic device 140 and/or a face of a suspicious individual 142 may be detected and stored when the suspicious individual 142 enters the zone 132-2. The electronic device ID 133 and/or an image of the face may be transmitted to the cloud-based computing device 116 or the computing device 102 via the network 112. In some instances, the suspicious individual 142 may be contacted on their electronic device 140 with a message indicating the homeowner is aware of their presence and to leave the premises. In some instances, if a known criminal individual 142 with a warrant is detected at the combination of zones 122 and 132-1 at an entrance or at the zone 132-2 and 150 at the home, then the proper law enforcement agency may be contacted with the whereabouts of the individual 142.

In some embodiments, the cameras 120 may be located in the facial detection zones 150. Although just one camera 120 and one facial detection zone 150 are depicted, it should be noted that any suitable number of cameras 120 may be located in any suitable number of facial detection zones 122. For example, multiple facial detection zones 150 may be used to cover a desired area. A facial detection zone 150 may refer to an area of coverage that is within the cameras' 120 field of view. The cameras 120 may be any suitable camera and/or video camera capable of capturing a set of images 123 that at least represent faces of an individual 142 that enters the facial detection zone 150. The set of images 123 may be transmitted by the camera 120 to the cloud-based computing system 116 and/or the computing device 102 via the network 112. In some embodiments, the cloud-based computing system 116 and/or the computing device 102 may perform facial recognition by comparing a face detected in the image to a database of faces to find a match and/or perform biometric artificial intelligence that may uniquely identify an individual 142 by analyzing patterns based on the individual's facial textures and shape.

The electronic device identification sensors 130 may be configured to detect a set of electronic device IDs 133 (e.g., Wi-Fi MAC addresses, Bluetooth MAC addresses, and/or cellular MAC addresses) of electronic device 140 within the electronic device detection zone 132. As depicted, the electronic device 140 of a suspicious individual is within the vehicle 126 passing through the electronic device detection zone 132. That is, the electronic device identification sensors 130 may be any suitable Wi-Fi signal detection device capable of detecting Wi-Fi MAC addresses and/or Bluetooth signal detection device capable of detecting Bluetooth MAC addresses of electronic devices 140 that enter the electronic device detection zone 132. The set of images 123 may be transmitted by the camera 120 to the cloud-based computing system 116 and/or the computing device 102 via the network 112. The electronic device identification sensor 130 may store the set of electronic device IDs 133 locally in a memory. The electronic device identification sensor 130 may also transmit the set of electronic device IDs 133 to the cloud-based computing system 116 and/or the computing device 102 via the network 112 for storage.

As noted above, the cloud-based computing system 116 may include the one or more servers 118 that form a distributed computing architecture. Each of the servers 118 may be any suitable computing system and may include one or more processing devices, memory devices, data storage, and/or network interface devices. The servers 118 may be in communication with one another via any suitable communication protocol. The servers 118 may each include at least one trusted vehicle license plate IDs database 117 and at least one personal identification database 119. In some embodiments, the databases 117 and 119 may be stored on the computing device 102.

The database 117 of trusted vehicle license plate IDs may be populated by a processing device adding license plate IDs of vehicles that commonly enter the license plate detection zone 122. In some implementations, the database 117 of trusted vehicle license plate IDs may be populated at least in part by manual entry of license plate IDs associated with vehicles trusted to be within the license plate detection zone 122. For example, the license plate IDs may be added at a manual input zone 160-1 using a computing device 161. These license plate IDs may be associated with vehicles owned by neighbors in a neighborhood, or family members of the neighbors, friends of the neighbors, visitors of the neighbors, contractors hired by the neighbors, any suitable person that is trusted, etc.

The personal identification database 119 may be populated by a processing device adding personal identification information associated with electronic device IDs 133 of electronic devices carried by people that commonly enter the electronic device detection zone 132 (e.g., a list of trusted electronic device IDs). In some embodiments, the personal identification database 119 may be populated at least in part by manual entry of personal identification information associated with electronic device IDs 133 associated with electronic devices 140 trusted to be within the electronic device detection zone 132 (e.g., a list of trusted electronic device IDs). For example, the personal identification information associated with electronic device IDs 133 may be added at the manual input zone 160-1 using the computing device 161. These electronic device IDs 133 may be associated with electronic devices 140 owned by neighbors in a neighborhood, or family members of the neighbors, friends of the neighbors, visitors of the neighbors, contractors hired by the neighbors, etc. Further, in some embodiments, the personal identification database 119 may be populated by entering a list of known suspect individuals from the police department, people entering or exiting border checkpoints, etc.

The personal identification information for untrusted electronic device IDs may also be entered into the personal identification database 119. The personal identification database 119 may also be populated by a processing device adding personal identification information associated with electronic device IDs 133 of electronic devices carried by people that commonly enter the facial detection zone 132 (e.g., face images of trusted individuals). The face images 123 may be manually entered at manual input zone 160-2 using the computing device 161. The personal identification information may include names, addresses, faces, email addresses, phone numbers, electronic device identifiers associated with electronic devices owned by the people (e.g., Bluetooth MAC addresses, Wi-Fi MAC addresses), correlated license plate IDs with the electronic device identifiers, etc. The correlations between the license plate IDs, the electronic device identifiers, and/or the faces may be performed by a processing device using the data obtained from the cameras 120 and the electronic device identification sensors 130. Some of this information may be obtained from public sources, phone books, the Internet, and/or companies that distribute electronic devices. In some embodiments, the personal identification information added to the personal identification database 119 may be associated with people selected based on their residing in or near a certain radius of a geographic region where the zones 122 and/or 132 are set up, based on whether they are on a crime watch list, or the like.

In some embodiments, the system 100 uses overlapping detection zones of multiple electronic device identification sensors to narrow the location area of an individual. For example, in FIG. 1B, the three detection zones 132-1, 132-2, and 132-3 of the three electronic device identification sensors 130-1, 130-2, and 130-3 partially overlap with each other. Further, the individual 142 in FIG. 1B is positioned within the overlapping portions of the three detection zones 132-1, 132-2, and 132-3. Thus, when all three electronic device identification sensors 130-1, 130-2, and 130-3 detect an electronic device carried by the individual 142, the system 100 may determine that the individual 142 is located within the overlapping portions of the three detection zones 132-1, 132-2, and 132-3.

In some embodiments, the system 100 may further narrow the location area of the individual 142 using trilateration (or multilateration). Each of the three electronic device identification sensors 130-1, 130-2, and 130-3 may determine, based on the signal strength of the electronic device carried by the individual 142, the distance to the individual 142. For example, electronic device identification sensor 130-2 may determine that the electronic device carried by the individual 142 is close to electronic device identification sensor 130-2 when the signal strength is strong or determine that the electronic device is far from electronic device identification sensor 130-2 when the signal strength is weak. Alternatively, or in addition, each of the three electronic device identification sensors 130-1, 130-2, and 130-3 may determine the distance to the individual 142 by measuring the time delay that a signal takes to return to the electronic device identification sensors 130-1, 130-2, and 130-3 from the electronic device carried by the individual 142. For example, electronic device identification sensor 130-3 may determine that the electronic device carried by the individual 142 is close to electronic device identification sensor 130-3 when the time delay is short or determine that the electronic device is far from electronic device identification sensor 130-3 when the time delay is long. “Short” and “long,” as used in the foregoing may refer to any amount of time delay without restriction, so long that the constraint, in any given instance, is that a long time delay be for a greater period of time than a short time delay. The system 100 may, based on the locations of each of the three electronic device identification sensors 130-1, 130-2, and 130-3 and the distances from the electronic device to each of the three

$$x = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {y}_{3} - 2 {y}_{3} ) - \\ ( {r}_{2}^{2} - {r}_{3}^{2} - {x}_{2}^{2} + {x}_{3}^{2} - {y}_{2}^{2} + {y}_{3}^{2} ) ( 2 {y}_{2} - 2 {y}_{1} )\end{matrix}}{( 2 {y}_{3} - 2 {y}_{3} ) ( 2 {x}_{2} - 2 {x}_{1} ) - ( 2 {y}_{2} - 2 {y}_{1} ) ( 2 {x}_{3} - 2 {x}_{2} )}$$

$$y = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {x}_{3} - 2 {x}_{2} ) - \\ ( 2 {x}_{2} - 2 {x}_{1} ) ( {r}_{2}^{2} - {r}_{3}^{2} - {x}_{2}^{2} + {x}_{3}^{2} - {y}_{2}^{2} + {y}_{3}^{2} )\end{matrix}}{( 2 {y}_{2} - 2 {y}_{1} ) ( 2 {x}_{3} - 2 {x}_{2} ) - ( 2 {x}_{2} - 2 {x}_{1} ) ( 2 {y}_{3} - 2 {y}_{3} )}$$

electronic device identification sensors 130-1, 130-2, and 130-3, determine the coordinates of the electronic device. For example, the system 100 may determine the coordinates of the electronic device using the follow equations:
wherein:
   x, y=coordinates of the electronic device carried by the individual 142;
   x₁, y₁=coordinates of electronic device identification sensor 130-1;
   r₁=distance between electronic device identification sensor 130-1 and the electronic device;
   x₂, y₂=coordinates of electronic device identification sensor 130-2;
   r₂=distance between electronic device identification sensor 130-2 and the electronic device;
   x₃, y₃=coordinates of electronic device identification sensor 130-3; and
   r₃=distance between electronic device identification sensor 130-3 and the electronic device.

Alternatively, or in addition, the system 100 may further narrow the location area of the individual 142 by selecting a different type of detection device located within the overlapping portions of the three detection zones 132-1, 132-2, and 132-3. For example, there are two cameras 120-1 and 120-2 in FIG. 1B with different facial detection zones 150-1 and 150-2. When all three electronic device identification sensors 130-1, 130-2, and 130-3 detect an electronic device carried by the individual 142, the system 100 may select camera 120-2 with facial detection zone 150-2 that is located within the overlapping portions of the three detection zones 132-1, 132-2, and 132-3. The selected camera 120-2 may then detect the location of the individual 142 within facial detection zone 150-2.

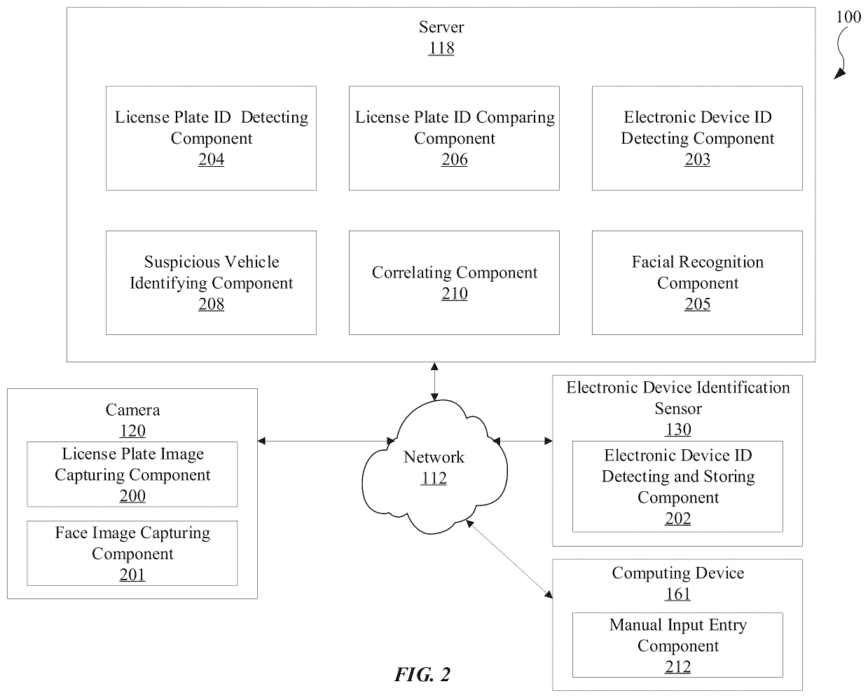

FIG. 2 illustrates details pertaining to various components of the system architecture 100 of FIG. 1A, according to certain embodiments of this disclosure. For example, the camera 120 includes an image capturing component 200 and a face image capturing component 201; the electronic device identification sensor 130 includes an electronic device ID detecting and storing component 202; the server 118 includes an electronic device ID detecting component 203, a license plate ID detecting component 204, a facial recognition component 205, a license plate ID comparing component 206, a suspicious vehicle identifying component 208, and a correlating component 210. In some embodiments, the computing device 161 includes a manual input entry component 212. In some embodiments, the components 203, 204, 205, 206, 208, and 210 may be included in the computing device 102 executing the client application 104. Each of the components 200, 201, 202, 203, 204, 205, 206, 208, 210, and 212 may be implemented in computer instructions stored on one or more memory devices of their respective device and executed by one or more processors of their respective device.

With regards to the image capturing component 200, the component 200 may be configured to capture a set of images 123 within a license plate detection zone 122. At least some of the captured images 123 may represent license plates of a set of vehicles 126 appearing within the field of view of the cameras 120. The image capturing component 200 may configure one or more camera properties (e.g., zoom, focus, etc.) to obtain a clear image of the license plates. The image capturing component 200 may implement various techniques to extract the license plate ID from the images 123, or the image capturing component 200 may transmit the set of images 123, without analyzing the images 123, to the server 118 via the network 112.

With regards to the electronic device ID detecting and storing component 202, the component 202 may be configured to detect and store a set of electronic device IDs 133 of electronic devices located within one or more electronic device detection zones 132. The electronic device ID detecting and storing component 202 may detect a Wi-Fi signal, cellular signal, and/or a Bluetooth signal from the electronic device and be capable of obtaining the Wi-Fi MAC address, cellular MAC address, and/or Bluetooth MAC address of the electronic device from the signal. The electronic device IDs 133 may be stored locally in memory on the electronic device identification sensor 130, and/or transmitted to the server 118 and/or the computing device 102 via the network 112.

With regards to the license plate ID detecting component 204, the component 204 may be configured to detect, using the set of images 123, a license plate ID of a vehicle 126. The license plate ID detecting component 204 may perform optical character recognition (OCR), or any suitable identifier/text extraction technique, on the set of images 123 to detect the license plate IDs.

With regards to the license plate ID comparing component 206, the component 206 may be configured to compare the license plate ID of the vehicle to a database 117 of trusted vehicle license plate IDs. The license plate ID comparing component 206 may compare the license plate ID with each trusted license plate ID in the database 117 of trusted vehicle license plate IDs.

With regards to the suspicious vehicle identifying component 208, the component 208 may identify the vehicle 126 as a suspicious vehicle 126, the identification based at least in part on the comparison of the license plate ID of the vehicle 126 to the database 117 of trusted vehicle license plate IDs. If there is not a trusted license plate ID that matches the license plate ID of the vehicle 126, then the suspicious vehicle identifying component 208 may identify the vehicle as a suspicious vehicle.

With regards to the correlating component 210, the component 210 may be configured to correlate the license plate ID of the vehicle 126 with at least one of the set of stored electronic device IDs 133. Correlating the license plate ID of the vehicle 126 with at least one of the set of stored electronic device IDs 133 may include comparing one or more time stamps of the set of captured images 123 with one or more time stamps of the set of stored electronic device IDs 133. Also, correlating the license plate ID of the vehicle 126 with at least one of the set of stored electronic device IDs 133 may include analyzing at least one of: (i) at least one strength of signal associated with at least one of the set of stored electronic device IDs 133, and (ii) at least one visually estimated distance of at least one vehicle 126 associated with at least one of the set of stored images 123.

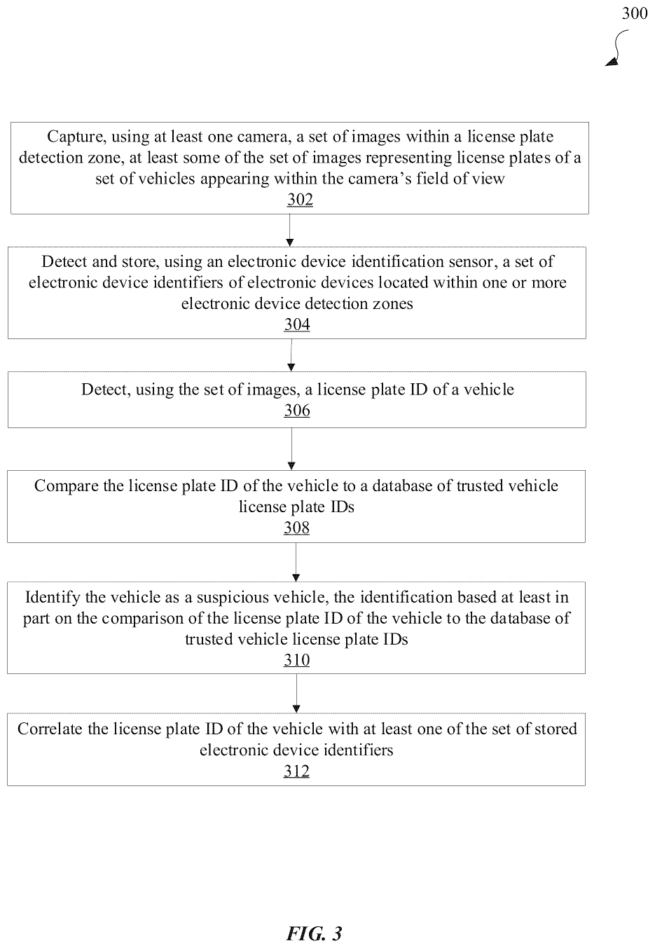

FIG. 3 illustrates an example of a method 300 for monitoring vehicle traffic, according to certain embodiments of this disclosure. The method 300 may be performed by processing logic that may include hardware (circuitry, dedicated logic, etc.), firmware, software, or a combination of both. The method 300 and/or each of their individual functions, subroutines, or operations may be performed by one or more processors of one or more of the devices in FIG. 1A (e.g., computing device 102, cloud-based computing system 116 including servers 118, cameras 120, electronic device identification sensors 130) implementing the method 300. For example, a computing system may refer to the computing device 102 or the cloud-based computing system 116. The method 300 may be implemented as computer instructions that, when executed by a processing device, execute the operations. In certain implementations, the method 300 may be performed by a single processing thread. Alternatively, the method 300 may be performed by two or more processing threads, each thread implementing one or more individual functions, routines, subroutines, or operations of the method 300.

At block 302, a set of images 123 may be captured, using at least one camera 120, within a license plate detection zone 122. At least some of the set of images 123 may represent license plates of a set of vehicles 126 appearing within the camera's field of view. One or more camera properties (e.g., zoomed in, focused, etc.) may be configured to enable the at least one instance of the camera 120 to obtain clear images 123 of the license plates.

At block 304, a set of electronic device identifiers 133 of electronic devices 140 located within one or more electronic device detection zones 132 may be detected and stored using an electronic device identification sensor 130. In some embodiments, the electronic device identification sensor 130 may include at least one of a Wi-Fi signal detection device, cellular signal detection device, or a Bluetooth signal detection device. In some embodiments, the set of electronic device identifiers 133 may include at least one of a Bluetooth MAC address, cellular MAC address, or a Wi-Fi MAC address. In some embodiments, at least one of the set of stored electronic device identifiers 133 may be compared with a list of trusted device identifiers.

At block 306, a license plate ID of a vehicle 126 may be detected using the set of images 123. The images 123 may be filtered, rendered, and/or processed in any suitable manner such that the license plate IDs may be clearly detected using the set of images 123. In some embodiments, object character recognition (OCR) may be used to detect the license plate IDs in the set of images 123. The OCR may electronically convert each image in the set of images 123 of the license plate IDs into computer-encoded license plate IDs that may be stored and/or used for comparison.

In some embodiments, a face of the individual 142 may be detected by a camera 120 in the facial detection zone 150. An image 123 may be captured by the camera 120 and facial recognition may be performed on the image to detect the face of the individual. The detected face and/or the image 123 may be transmitted to the cloud-based computing system 116 and/or the computing device 102.

At block 308, the license plate ID of the vehicle 126 may be compared to a database of trusted vehicle license plate IDs. In some embodiments, the database 117 of trusted vehicle license plate IDs may be populated at least in part by adding license plate IDs of vehicles 126 that commonly enter the license plate detection zone 122 to the database 117 of trusted vehicle license plate IDs. In some embodiments, the database 117 of trusted vehicle license plate IDs may be populated at least in part by manual entry of license plate IDs associated with vehicles 126 trusted to be within the license plate detection zone 122. For example, the trusted vehicles may belong to the neighbors, family members of the neighbors, friends of the neighbors, law enforcement, and so forth.

At block 310, the vehicle may be identified as a suspicious vehicle 126. The identification may be based at least in part on the comparison of the license plate ID of the vehicle to the database 117 of trusted vehicle license plate IDs. For example, if the license plate ID is not matched with a trusted license plate ID stored in the database 117 of trusted vehicle license plate IDs, then the vehicle associated with the license plate ID may be identified as a suspicious vehicle 126.

At block 312, the license plate ID of the vehicle 126 may be correlated with at least one of the set of stored electronic device identifiers 133. In some embodiments, the face of the individual 142 may also be correlated with the license plate ID and the at least one of the set of stored electronic device identifiers 133. In some embodiments, the personal identification database 119 may be accessed. In some embodiments, correlating the license plate ID of the vehicle 126 with at least one of the set of stored electronic device identifiers 133 may include comparing one or more time stamps of the set of captured images 123 with one or more time stamps of the set of stored electronic device identifiers 133. In some embodiments, correlating the license plate ID of the vehicle 126 with the at least one of the set of stored electronic device identifiers 133 may include analyzing at least one of (i) at least one strength of signal associated with at least one of the set of stored electronic device identifiers 133, and (ii) at least one visually estimated distance of at least one vehicle associated with at least one of the set of stored images 123.

Personal identification information of at least one suspicious individual may be retrieved from the at least one personal identification database 119 by correlating information of the personal identification database 119 with the license plate ID of the vehicle 126 or at least one of the set of electronic device identifiers 133 correlated with the license plate ID of the vehicle 126. The personal identification information may also be obtained using a face detected by the camera 120 to obtain the electronic device ID 133 and/or the license plate ID correlated with the face. The personal identification information may include one or more of a name, a phone number, an email address, a residential address, a Bluetooth MAC address, a cellular MAC address, a Wi-Fi MAC address, whether the suspicious individual is on a crime watch list, a criminal record of the suspicious individual, and so forth.

In some embodiments, a user interface may be displayed on one or more computing devices 102 of one or more neighbors when the one or more computing devices are executing the client application 104, and the user interface may present a notification or alert. In some embodiments, the computing device 102 may present a push notification on the display screen and the user may provide user input (e.g., swipe the push notification) to expand the notification on the user interface to a larger portion of the display screen. The alert or notification may indicate that there is a suspicious vehicle 126 identified within the license plate detection zone 122 and/or the electronic device detection zone 132-1 and may provide information pertaining to the vehicle 126 (e.g., make, model, color, license plate ID, etc.) and personal identification information of the suspicious individual (e.g., name, phone number, email address, Bluetooth MAC address, cellular MAC address, Wi-Fi MAC address, whether the individual is on a crime watch list, whether the individual has a criminal record, etc.).

Further, the user interface may present one or more options to perform preventative actions. The preventative actions may include contacting an electronic device 140 of the suspicious individual using the personal identification information. For example, a user may use a computing device 102 to transmit a communication (e.g., at least one text message, phone call, email, or some combination thereof) to the suspicious individual using the retried personal information.

In addition, the preventative actions may also include notifying law enforcement of the suspicious vehicle and/or individual. This preventative action may be available if it is determined that the suspicious individual is on a crime watch list. A suspicious vehicle profile may be created. The suspicious vehicle profile may include the license plate ID of the suspicious vehicle and/or the at least one correlated electronic device identifiers (e.g., Bluetooth MAC address, Wi-Fi MAC address). The user may select the notify law enforcement option on the user interface and the computing device 102 of the user may transmit the suspicious vehicle profile to another computing device 102 of a law enforcement entity that may be logged into the client application 104 using a law enforcement account.

In some embodiments, the preventative action may include activating an alarm upon detection of the suspicious vehicle 126. The alarm may be located in the neighborhood, for example, on a light pole, a tree, a pole, a sign, a mailbox, a fence, or the like. The alarm may be included in the computing device 102 of a user (e.g., a neighbor) using the client application. The alarm may include auditory (e.g., a message about the suspect, a sound, etc.), visual (e.g., flash certain colors of lights), and/or haptic (e.g., vibrations) elements. In some embodiments, the severity of the alarm may change the pattern of auditory, visual, and/or haptic elements based on what kind of crimes the suspicious individual has committed, whether the suspicious vehicle 126 is stolen, whether the suspicious vehicle 126 matches a description of a vehicle involved in an Amber alert, and so forth.

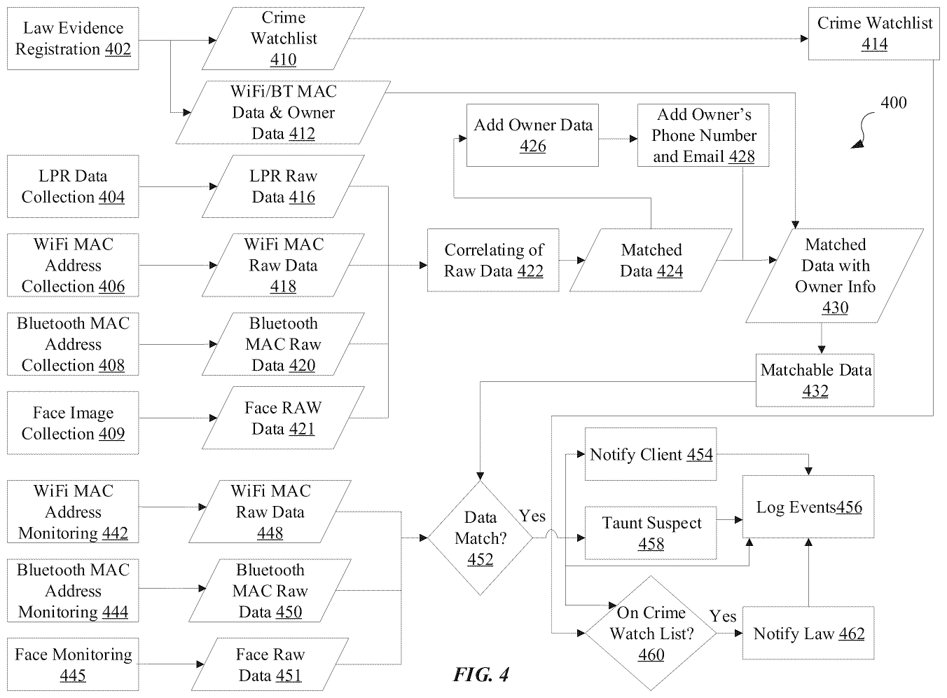

FIG. 4 illustrates another example method 400 for monitoring vehicle traffic, according to certain embodiments of this disclosure. Method 400 includes operations performed by one or more processing devices of one or more devices in FIG. 1A (e.g., computing device 102, cloud-based computing system 116 including servers 118, cameras 120, electronic device identification sensors 130) implementing the method 400. In some embodiments, one or more operations of the method 400 are implemented in computer instructions that, when executed by a processing device, execute the operations of the steps. The method 400 may be performed in the same or a similar manner as described above in regards to method 300.

The method 400 may begin with a setup phase where various steps 402, 404, 406, 408, and/or 409 are performed to register data that may be used to determine whether a vehicle and/or individual is suspicious. For example, at block 402, law evidence may be registered. The law evidence may be obtained from a system of a law enforcement agency. For example, an application programming interface (API) of the law enforcement system may be exposed and API operations may be executed to obtain the law evidence. The law evidence may indicate whether a person is on a crime watch list 410, whether the person has a warrant, whether person has a criminal record, and/or the Wi-Fi/Bluetooth MAC data (address)/cellular data of electronic devices involved in incidents, as well as the owner information 412 of the electronic devices. The crime watch list 410 information may be used to store crime watch list 414 in a database (e.g., personal identification database 119).

At block 404, license plate registration (LPR) data may be collected using the one or more cameras 120 in the license plate detection zones 122 as LPR raw data 416. The LPR raw data 416 may be used to obtain vehicle owner information (e.g., name, address, phone number, email address) and vehicle information (e.g., license plate ID, make, model, color, year, etc.). For example, the LPR raw data 416 may include at least the license plate ID, which may be used to search the Department of Motor Vehicles (DMV) to obtain the vehicle owner information and/or vehicle information. In some instances, the LPR raw data 416 may be collected from manual entry. At block 406, Wi-Fi MAC addresses may be collected from various sources as Wi-Fi MAC raw data 418. For example, the Wi-Fi MAC raw data 418 may be collected from the electronic device identification sensors 130 in the electronic device detection zones 132. In some instances, trusted Wi-Fi MAC addresses may be manually obtained from certain people owning electronic devices in an area covered by the electronic device detection zones 132 and stored in a database (e.g., personal identification database 119). In some embodiments, cellular raw data (e.g., cellular MAC addresses) may be collected from electronic device identification sensors 130. At block 408, Bluetooth MAC addresses may be collected from various sources as Bluetooth MAC raw data 420. For example, the Bluetooth MAC raw data 418 may be collected from the electronic device identification sensors 130 in the electronic device detection zones 132. In some instances, trusted Bluetooth MAC addresses may be manually obtained from certain people owning electronic devices in an area covered by the electronic device detection zones 132 and stored in a database (e.g., personal identification database 119). In some embodiments, the Bluetooth MAC addresses may be collected from the electronic device identification sensors 130 at the electronic device detection zones 132. At block 409, face images may be collected as raw data 421 by the one or more cameras 120 in the facial detection zones 150. Facial recognition may be performed to detect and recognize faces in the face images.

At block 422, the LPR raw data 416, the Wi-Fi MAC raw data 418, the Bluetooth MAC raw data 420, the cellular raw data, and/or the face raw data 421 may be correlated or paired to generate matched data 424. That is, the data from license plate ID detection, LPR systems, personal electronic device detection, and/or facial information may be combined to generate matched data 424 and stored in the database 117 of trusted vehicle license plate IDs and/or the personal identification database 119. In some embodiments, the license plate IDs are compared to the personal identification database 119 of trusted vehicle license plate IDs to determine whether the detected license plate ID is in the database 117 of trusted vehicle license plate IDs. If not, the vehicle 126 may be identified as a suspicious vehicle and the license plate ID of the vehicle may be correlated with at least one of the set of stored electronic device IDs 133. This may result in creation of a database of detected electronic device identifiers 133 correlated with license plate IDs and facial information of individuals. Any unpaired data may be discarded after unsuccessful pairing.

At block 426, owner data of the electronic devices and/or vehicle may be added to the matched data 424. The owner data may include an owner ID, and/or name, address, and the like. Further, at block 428, owner's phone number and email may be added to the matched data. In addition, Wi-Fi/Bluetooth MAC/cellular data and owner data 412 from the law evidence may be included with the matched data 424 and the personal information of the owner to generate matched data with owner information 430. Accordingly, the owner ID may be associated with combined personal information (e.g., name, address, phone number, email, etc.), vehicle information (e.g., license plate ID, make, model, color, year, vehicle owner information, etc.), and electronic device IDs 133 (e.g., Wi-Fi MAC address, Bluetooth MAC adder). At block 432, the matched data with owner information 430 may be further processed (e.g., formatted, edited, etc.) to generate matchable data. This may conclude the setup phase.

Next, the method 400 may include a monitoring phase. During this phase, the method 400 may include blocks 442, 444, and 445. At block 442, Wi-Fi MAC address monitoring may include one or more electronic device identification sensors 130 detecting and storing a set of Wi-Fi MAC addresses as Wi-Fi MAC raw data 448. In some embodiments, cellular signal monitoring may include one or more electronic device identification sensors 130 detecting and storing a set of cellular MAC addresses as cellular raw data. At block 444, Bluetooth MAC address monitoring may include one or more electronic device identification sensors 130 detecting and storing a set of Bluetooth MAC addresses as Bluetooth MAC raw data 450. At block 445, face monitoring may include the one or more cameras 120 capturing face images and recognizing faces in the face images as face raw data 451. The Wi-Fi MAC raw data 448, Bluetooth MAC raw data 450, and/or face raw data 451 may be compared to matchable data 432 at decision block 452.

At block 452, the electronic device IDs 133 and/or faces detected by the electronic device identification sensors 130 and/or the cameras 120 may be compared to the matchable data. The matchable data may include personal identification information that is retrieved from at least the personal identification database 119. That is, the detected electronic device IDs 133 and/or faces may be compared to the database 117 of trusted vehicle license plate IDs and/or the personal identification database 119 to find any correlation of the detected electronic device IDs 133 and/or faces with license plate IDs.

If there is a matching electronic device ID to the detected electronic device ID and/or a matching face to the detected face, and there is a correlation with a license plate ID in the database 117 of trusted vehicle license plate IDs and/or the personal identification database 119, then a suspicious vehicle 126/individual 143 may be detected. At block 456, the detected match event may be logged. At block 454, the user interface of the client application 104 executing on the computing device 102 may present an alert of the suspicious vehicle 126/individual 142. At block 456, the detected notification event may be logged. At block 458, the electronic device 140 of the suspicious individual 142 may be notified that his presence is known (e.g., taunted). At block 456, the taunting event may be logged.

At decision block 460, the crime watch list 414 may be used to determine if the identified individual 142 is on the crime watch list 414 using the individual's personal information. If the individual 142 is on the watch list 414, then at block 462, the appropriate law enforcement agency may be notified. At block 456, the law enforcement agency notification event may be logged.

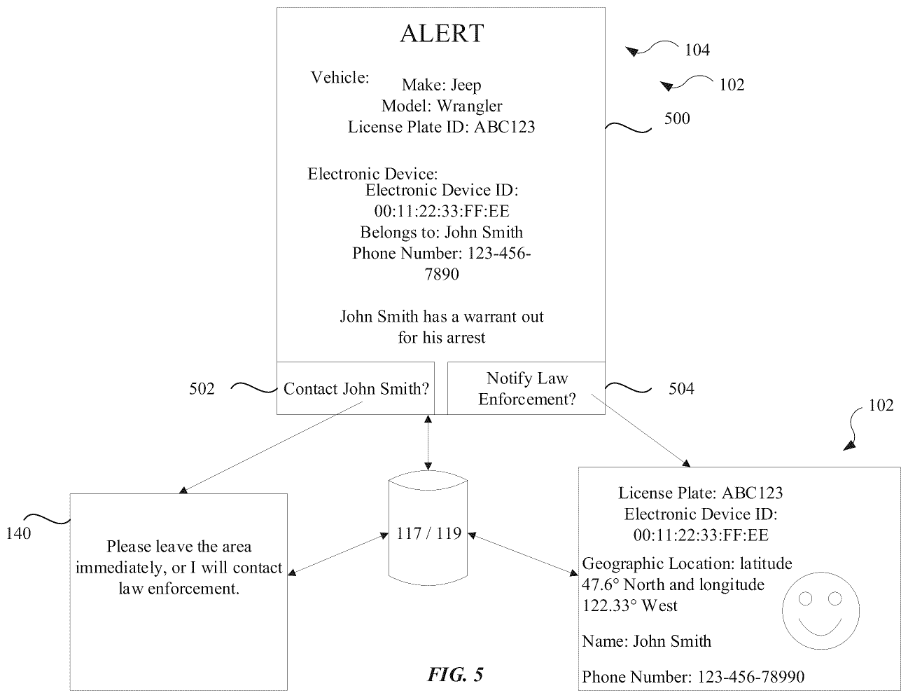

FIG. 5 illustrates example use interfaces presented on computing devices during monitoring vehicle traffic, according to certain embodiments of this disclosure. It should be noted that a user interface 500 may present vehicle information and electronic device information in a single user interface. When a suspicious vehicle 126/individual 142 is detected based on the vehicle license plate ID and/or the electronic device IDs 133, a notification may be presented on the user interface 500 of the client application 104 executing on the computing device 102 of a user (e.g., homeowner, neighbor, interested citizen). As depicted, the notification includes an alert displaying vehicle information and electronic device information. The vehicle information includes the “Make: Jeep”, “Model: Wrangler”, “License Plate ID: ABC123”. The electronic device information includes “Electronic Device ID: 00:11:22:33: FF: EE”, “Belongs to: John Smith”, “Phone Number: 123-456-7890”. Further, the user interface 500 presents that the owner has a warrant out for his arrest. The notification event may be logged in the database 117/119 or any suitable database of the system 100.

The user interface 500 includes various preventative action options represented by user interface clement 502 and 504. For example, user interface element 502 may be associated with contacting the detected suspicious individual 142 directly. Upon selection of the user interface element 502, the user may be able to send a text message to the electronic device 140 of the suspicious individual 142. For example, the text message may read “Please leave the area immediately, or I will contact law enforcement.” However, any suitable message may be sent. The message/taunting event may be logged in the database 117/119 or any suitable database of the system architecture 100.

Since the suspicious individual 142 has a warrant out for his arrest and/or is on a crime watch list, the user interface element 504 may be displayed that provides the option to notify law enforcement. Upon selection of the user interface element 504, a notification may be transmitted to a computing device 102 of a law enforcement agency. The notification may include vehicle information (e.g., “License Plate ID: ABC123”), electronic device information (e.g., “Electronic Device ID: 00:11:22:33: FF: EE”), as well as location of the detection (e.g., “Geographic Location: latitude 47.6° North and longitude 122.33° West”), and personal information (“Name: John Smith”, “Phone Number: 123-456-7890”, a face of the individual 142). The law enforcement agency event may be logged in the database 117/119 or any suitable database of the system 100.

Below are example data tables that may be used to implement the system and method for monitoring vehicle traffic disclosed herein. The data tables may include: Client and ID Tables (logID, loginAttempts, clientUser, lawUser, billing), Data Site Info (monitoredSites, dataSites, dataGroups), Raw Collection Data (rawWiFiDataFound, rawBTDataFound, rawLPRDataFound, pairedData), Monitor Data Raw & Matched (monWiFiDataDetected, monBTDataDetected, monWiFiDataMatched, monBTDataMatched), Subject Data (subjectMatch, subjectInfo, subjectLastSeen, criminalWatchList), Notification Logs (subNotifyLog, subNotifyReplyLog, clientNotifyLog).

loginID
Table 1: logID is used for login ID/passwords,
authentication and password resets
loginID

username
clientID
idType
rights
email
password
lastLogin

TABLE 2
loginAttempts
Table 2: loginAttempts logs the number of times
logins were attempted for both successes and failures
loginAttempts

clientID
username
timeStamp
IP
wifiRSSI
wifiVendor
wifiLocDet
scanInt

TABLE 3
clientUser
Table 3: clientUser includes information for each user.
clientUser

clientID
username
firstName
lastName
phone1
phone2
phone3
email1
email2
email3
txt1
txt2
txt3
lastUserName
dataIDs
lawID
monID

TABLE 4
lawUser
Table 4: lawUser includes information for law enforcement persononel
wanting to be notified of suspicious vehicles 126/individuals 142.
lawUser

lawUserName
lawID
lawType
lawPrecinct
lawDept
firstName
lastName
phone1
phone2
phone3
email1
email2
email3
txt1
txt2
Txt3
alertType

TABLE 5
billing
Table 5: billing may be used for third-party billing.
billing

clientID
username
package
numMons
options
cardType
cardName
cardAddr1
cardAddr2
cardCity
cardState
cardZIP
cardNum
cardExp
cardID

TABLE 6
monitoredSites
Table 6: monitoredSites includes information for WiFi/
Bluetooth monitoring for detection, among other things.
monitoredSites

monID
monGroupID
clientID
monAddr1
monAddr2
monCity
monState
monZIP
monCountry

TABLE 7
dataSites
Table 7: dataSites includes information for WiFi/
Bluetooth/License Plate Registration detection sites. These
sites may supply data to databases, among other things.
dataSites

dataID
dataAddr1
dataAddr2
dataCity
dataState
dataZIP
dataCountry
groupNum
hwModel
hwSerialNum
softVersion
installDate
devLoc
notes

TABLE 8
dataGroups
Table 8: dataGroups may group data groups and monitored sites.
Groupings such as Homeowner Associations, neighborhoods, etc.
dataGroups

groupID
groupName
groupLocation
groupAddr1
groupAddr2
groupCity
groupState
groupZIP
groupCountry
info

TABLE 9
rawWiFiDataFound
Table 9: rawWiFiDataFound includes raw data dump for
WiFi from detection sites used to look for matches.
rawWiFiDataFound

timeStamp
wifiSync
wifiMAC
wifiDevice
wifiRSSI
wifiVendor
wifiLocDet
scanInt

TABLE 10
rawBTDataFound
Table 10: rawBTDataFound includes raw data dump for
Bluetooth from detection sites used to look for matches.
rawBTDataFound

timeStamp
btSync
btMAC
btName
btRSSI
btVendor
btCOD
btLocDet
scanInt

TABLE 11
rawLPRDataFound
Table 11: rawLPRDataFound may include raw LPR
data from detection sites used to look for matches.
rawLPRDataFound

| | |
|---|---|
| timeStamp | lprPic3 |
| lprPlate | lprPic4 |
| lprState | lprPic5 |
| lpreMake | lprPic6 |
| lprModel | lprPic7 |
| lprPlatePic | lprPic8 |
| lprPic1 | lprLocDet |
| lprPic2 | scanInt |

TABLE 12
pairedData
Table 12: pairedData includes matched data that may
be the correlation between vehicle information (e.g.,
license plate IDs) and electronic device IDs 133.
pairedData

| | |
|---|---|
| pairedID | btCOD |
| timeStamp | wifiLocDet |
| lprTimeStamp | btLocDet |
| wifiTimeStamp | lprLocDet |
| btTimeStamp | lprPlatePic |
| lprPlate | lprPic1 |
| lprState | lprPic2 |
| lprMake | lprPic3 |
| lprModel | lprPic4 |
| wifiMAC | lprPic5 |
| wifiDevice | lprPic6 |
| wifiVendor | lprPic7 |
| btMAC | lprPic8 |
| btName | subjectID |
| btVendor | |

TABLE 13
monWiFiDataDetected
Table 13: monWiFiDataDetected logs of any MAC
address data detefcted before matching for WiFi.
monWiFiDataDetected

timestamp
wifiSync
wifiMAC
wifiDevice
wifiRSSI
wifiVendor
wifiMonLoc

TABLE 14
monBTDataDetected
Table 14: monBTDataDetected logs of any MAC
address data detected before matching for Bluetooth.
monBTDataDetected

timestamp
btSync
btMAC
btName
btRSSI
btVendor
btCOD

TABLE 15
monWiFiDataMatched
Table 15: monWiFiDataMatched logs of any matches
moniroted sites find on the database for WiFi.
monWiFiDataMatched

pairedID
timestamp
wifiSync
wifiMAC
wifiDevice
wifiRSSI
wifiVendor
wifiMonLoc

TABLE 16
monBTDataMatched
Table 16: monBTDataMatched logs of any matches
monitored sites find on the database for Bluetooth.
monBTDataMatched

pairedID
timestamp
btSync
btMAC
btName
btRSSI
btVendor
btCOD
btMonLoc

TABLE 17
subjectMatch
Table 17: subjectMatch includes a number of times
subject detected in monitored sites and data sites.
subjectMatch

subjectID
subjectWiFiMAC
subjectBtMAC
timeStamp

TABLE 18
subjectInfo
Table 18: subjectInfo includes information
obtained for owner of license vehicle.
subjectInfo

| | |
|---|---|
| subjectID | subPhone1 |
| subFirstName | subPhone2 |
| subLastName | subPhone3 |
| subDOB | subPhone4 |
| subAddr1 | subPhone5 |
| subAddr2 | subPhone6 |
| subCity | subTxt1 |
| subState | subTxt2 |
| subZIP | subTxt3 |

subjectLastSeen
Table 19: subjectLastSeen includes locations
where subject was seen with a timestamp.
subjectLastSeen

pairedID
timestamp
subjectID
locID
monID

TABLE 20
criminalWatchList
Table 20: criminalWatchList includes a criminal watch list
that is compared to subjects/individuals 142 to determine
if they are a criminal and who to notify if found.
criminalWatchList

subjectID
crimeType
dateCommitted
notifyIfDetected
status

TABLE 21
subNotifyLog
Table 21: subNotifyLog includes notifications
sent to the subject to discourage crime.
subNotifyLog

timestamp
clientID
subjectID
subPhoneTexted
msgSent
msgStatus

TABLE 22
subNotifyReplyLog
Table 22: subNotifyReplyLog includes any
replies from the subject after notification.
subNotifyReplyLog

timestamp
clientID
subjectID
subPhoneTexted
msgReceived

TABLE 23
clientNotifyLog
Table 23: clientNotifyLog includes log of notification
attempts to the client (e.g., computing device 102 of a user).
clientNotifyLog

timestamp
clientID
msgSent
msgStatus
msgType
numSent
emailSent

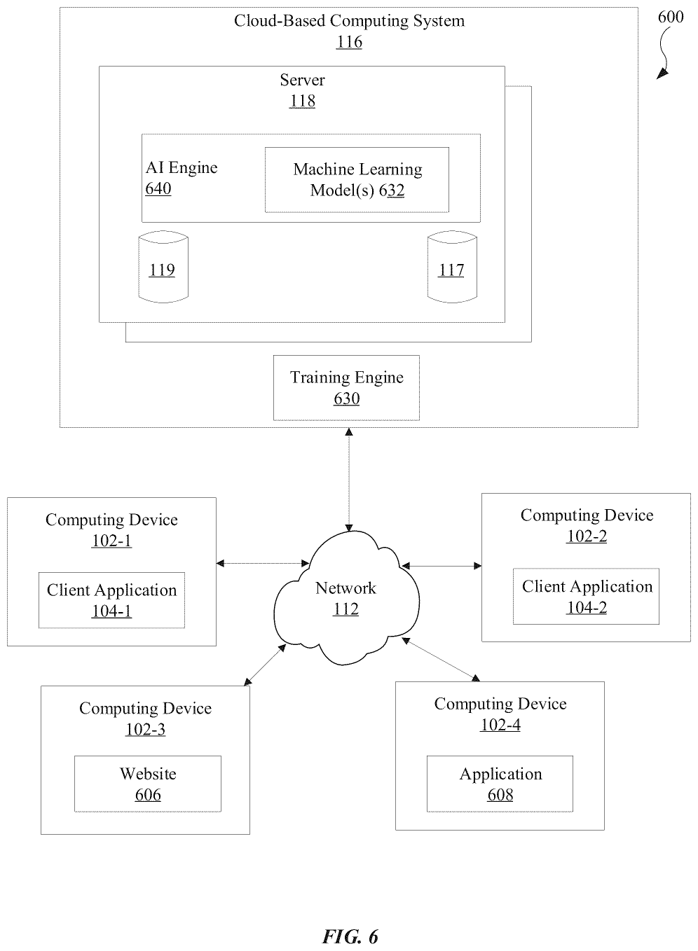

FIG. 6 illustrates another high-level component diagram of an illustrative system architecture 600, according to certain embodiments of this disclosure.

Meeting up with people, whether it is on a date or at an event, is associated with various risks and presents various technical problems. For example, one risk may involve the people that decide to meet up not knowing each other very well or even at all, and there is a possibility that one or more of the people may be bad actors and/or criminals (as used herein “criminals” includes, without limitation, convicts, ex-convicts, persons released from prison or jail who are on bail or probation and/or who are subject to restrictions such as house arrest and/or electronic monitoring, persons suspected of or indicted for crimes, persons on governmental watchlists (e.g., terrorism), persons associating with other individuals who are themselves criminals, persons with outstanding warrants, persons who are the subject of existing or prior restraining orders, persons on sex offender registries, and the like). Another risk may involve the people not knowing the area surrounding a selected meeting location and, if there is an elevated or especially high crime rate associated with that area, etc. Another risk is one or more of the people not showing up, being late, and the like. Further, even if people that decide to meet up know each other well (e.g., the people are married, the people are consanguineous, the people work together, etc.), a technical problem still exists as to determining where those people are relative to a meeting location at a certain meeting time.

In some embodiments, the present disclosure provides one or more technical solutions to the aforementioned technical problems. Some embodiments of the present disclosure enable tracking user location to facilitate safer meetups. For example, certain tracking information may be obtained and used to determine the respective locations of users' computing devices. The respective locations of the users may be tracked using various techniques. For example, the tracking information may be received via the cameras 120 and/or the electronic device identification sensors 130 in the license plate detection zone 122, the electronic device detection zone 132, and/or the facial detection zone 150. Further, the tracking information may include global positioning system data that is received from the computing devices 102.

Navigational guidance may be determined from the determining or triangulating the locations of the users' computing devices with respect to a meeting location. Each user's computing device may be presented with the location and navigational guidance of every other user who is meeting up at the meeting location. The computing devices of each user may display the locations of all of the other users' computing devices on a map in real-time as the users progress toward the meeting location. Such real-time tracking may provide some types of enhanced assurances that the users are going to safely meet up with the other users at the meeting location. In some embodiments, such techniques may deter dangerous individuals from participating in meetups because of the fear of being tracked.

In some embodiments, intentions of the users may be determined based on certain tracking information obtained from a calendar application, an electronic mail message, a text message, a messaging application, a voicemail, a search engine query, a web browser history, a location history of at least one of the two users' computing devices, or some combination thereof. The tracking information may indicate that the users intend to meet at a certain location at a certain time and date. For example, a text message from John to Kate may state “Let's get dinner tomorrow night at 7 PM at Tom's Steakhouse.” Some embodiments of the present disclosure may determine navigational instructions from each of John and Kate's computing devices to Tom's Steakhouse and provide the navigational instructions to each individual prior to the meeting.

Further, some embodiments of the present disclosure may provide oversight of the meet ups. For example, in some embodiments, a determination may be made if a user's computing device has strayed from a path specified by the navigational guidance and a preventative action may be performed (e.g., transmit a message to the user's computing device). Additionally, in some embodiments, a determination may be made if the user's computing device has not moved for longer than a threshold period of time, and a preventative action may be performed. In some embodiments, a determination may be made as to whether a user's computing device has powered down, and a preventative action may be performed. Further, in some embodiments, estimated times of arrival may be determined for the computing devices of the users that are meeting up. To enable the users to be aware of when to expect the other users to arrive at the meeting location, the estimated times of arrival may be provided to each of the computing devices for presentation. Such technological solutions may enable facilitating safer, more reliable, more enjoyable, and more relaxing meetups.

In addition, some embodiments may include determining a score associated with a user, where the score is based on various information obtained from one or more sources (e.g., social network sites, company sites, dating sites, etc.). The score may enable providing a recommendation as to whether or not another user should meet up with the user. In addition, in some embodiments, continuous, continual, or periodic monitoring of a user's information may be performed. If certain undesirable information is discovered (e.g., a police report of a heinous or other crime) for a first user, another user who is planning to meet up with the first user may be warned via a message.

In some embodiments, the system architecture 100 may include the cloud-based computing system 116, and computing devices 102-1, 102-2, 102-3, and 102-4 communicatively coupled via the network 112. The cloud-based computing system 116 may be a real-time software platform, include privacy software or protocols, or include security software or protocols. Each of the computing devices 102-1, 102-2, 102-3, and 102-4 and components included in the cloud-based computing system 116 may include one or more processing devices, memory devices, and/or network interface cards. The network interface cards may enable communication via a wireless protocol for transmitting data over short distances, such as Bluetooth, ZigBee, NFC, etc. Additionally, the network interface cards may enable communicating data via a wired protocol over short or long distances, and in one example, the computing devices 102-1, 102-2, 102-3, and 102-4 and/or the cloud-based computing system 116 may communicate with the network 112. Network 112 may be a public network (e.g., connected to the Internet via wired (Ethernet) or wireless (WiFi)) connections, a private network (e.g., a local area network (LAN) or wide area network (WAN)), or a combination thereof. In some embodiments, network 112 may also comprise a node or nodes on the Internet of Things (IOT).

The computing devices 102-1, 102-2, 102-3, and 102-4 may be any suitable computing device, such as an embedded computer device with display, a laptop, tablet, smartphone, smartwatch, an IoT device, or computer. The computing devices 102-1, 102-2, 102-3, and 102-4 may include a display capable of presenting a user interface of a client application 104-1 and 104-2, a website 606 (e.g., social networking website, online marketplace website, organization website, company website, content sharing website, chat forum website, gaming website, etc.), and/or an application 608 (e.g., messaging application, gaming application, etc.). The client application 104-1 and 104-2, the website 606, and/or the application 608 may be implemented in computer instructions stored on the one or more memory devices and executable by the one or more processing devices.

The user interface of the client applications 104-1 and 104-2 may present various screens to a user wherein the screens present various views including graphical user interfaces displaying geographical maps and icons representing the computing devices, as well as icons representing meeting locations, expected locations, and any suitable geographical landmarks. The user interfaces may present paths depicting navigational guidance from the computing devices to meeting locations and may provide real-time tracking to provide assurances to users that they are safely meeting up with the person they agreed to meet with or they are safely attending an event that they agreed to attend. In some embodiments, the user interfaces may provide notifications, messages, alerts, and/or warnings. For example, the user interface may present a notification if a computing device has strayed from a path by more than a threshold distance, may present a notification if a computing device has not moved from a current location for more than a threshold period of time, may present a notification if a computing device powers down, may provide a warning if a certain user is associated with a score below a threshold score level, may provide a warning if certain pejorative or concerning information associated with a user is discovered, may provide messages related to directions associated with navigational guidance, and the like. The computing devices 102-1, 102-2, 102-3, and 102-4 and the servers 118 may also include instructions stored on the one or more memory devices that, when executed by the one or more processing devices of the computing device 102, perform operations of any of the methods described herein.

In some embodiments, the cloud-based computing system 116 may include one or more servers 118 that form a distributed computing system, which may include a cloud computing system. The servers 118 may be a rackmount server, a router, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 118 may include one or more processing devices, memory devices, data storage, or network interface cards. The servers 118 may be in communication with one another via any suitable communication protocol. The servers 118 may execute an artificial intelligence engine 640 and one or more machine learning models 632, as described further herein.

That is, the servers 118 may execute an artificial intelligence (AI) engine 640 that uses one or more machine learning models 632 to perform at least one of the embodiments disclosed herein. The cloud-based computing system 116 may also include the databases 119 and/or 117 that may store data, knowledge, and data structures used to perform various embodiments. For example, the databases 117 and/or 119 may store user profiles that include information pertaining to dating history, user preferences, user characteristics (e.g., demographics, psychographics, etc.), event preferences, criminal records, and the like. The databases 117 and/or 119 may also store information pertaining to crime statistics associated with certain locations, traffic patterns, weather patterns, event schedules, and the like. Although depicted as part of the servers 118, in some embodiments, the databases 117 and/or 119 may be deployed separately from the servers 118.

In some embodiments, the cloud-based computing system 116 may include a training engine 630 capable of generating one or more machine learning models 632. Although depicted separately from the AI engine 640, the training engine 630 may, in some embodiments, be included in the Al engine 640 executing on the server 118. In some embodiments, the AI engine 640 may use the training engine 630 to generate the machine learning models 632 trained to perform inferencing and/or predicting operations, among other things. The one or more machine learning models 632 may be generated by the training engine 630 and may be implemented in computer instructions executable by one or more processing devices of the training engine 630 or the servers 628. To generate the one or more machine learning models 632, the training engine 630 may train the one or more machine learning models 632. The one or more machine learning models 632 may be used by any of the methods described herein.

The training engine 630 may be a rackmount server, a router, a personal computer, a portable digital assistant, a smartphone, a laptop computer, a tablet computer, a netbook, a desktop computer, an Internet of Things (IOT) device, any other desired computing device, or any combination of the above. The training engine 630 may, without limitation, be cloud-based or a real-time software platform, and the training engine may also include privacy software or protocols, or security software or protocols.

To generate the one or more machine learning models 632, the training engine 630 may train the one or more machine learning models 632. In some embodiments, the training engine 630 may use a base training data set including inputs of labeled data mapped to labeled outputs. The one or more machine learning models 632 may refer to model artifacts created by the training engine 630 wherein the training engine 630 uses training data that includes training inputs and corresponding target outputs. The training engine 630 may find patterns in the training data wherein such patterns map the training input to the target output and generate the machine learning models 632 that capture these patterns. Although depicted separately from the server 118. the training engine 630 may, in some embodiments, reside on server 118. Further, in some embodiments, the artificial intelligence engine 640, the databases 119 and/or 117, and/or the training engine 630 may reside on any of the computing devices 102-1, 102-2, 102-3, and 102-4.

As described in more detail below, the one or more machine learning models 632 may comprise, e.g., a single level of linear or non-linear operations (e.g., a support vector machine (SVM)) or the machine learning models 632 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each artificial neuron may transmit its output signal to the input of the remaining neurons as well as to itself). For example, the machine learning model may include numerous layers or hidden layers that perform calculations (e.g., dot products) using various neurons. In some embodiments, the one or more machine learning models 632 may be trained via supervised learning, unsupervised learning, and/or reinforcement learning.

The term “supervised learning,” when used in a machine learning context, may refer to a technique that uses labeled datasets to train algorithms to classify data or predict outcomes accurately. Labeled input data may be provided to a machine learning model that adjusts its weights and/or other parameters until the machine learning model is trained to properly identify labeled outputs. The algorithm measures the machine learning model's accuracy through a loss function by adjusting the weights and/or parameters until an error satisfies a threshold level.

The term “unsupervised learning,” when used in a machine learning context, may refer to a technique that, based on similarities and/or differences among the datasets, analyzes and clusters unlabeled datasets by identifying patterns or data groupings in the datasets. One example of unsupervised learning includes clustering. Clustering may refer to a data mining technique that groups unlabeled data based on the similarities or differences within different parts of the unlabeled data. Another example of unsupervised learning comprises association rules. Association rules may refer to a rule-based method for finding relationships between variables in a given dataset. Another example of unsupervised learning comprises dimensionality reduction. Dimensionality reduction may refer to a technique used when the number of features, or dimensions, in a dataset is too high. Dimensionality reduction reduces the number of data inputs to a manageable size while maintaining the integrity of the dataset.

The term “reinforcement learning,” when used in a machine learning context, may refer to a technique that enables an agent to learn in an interactive environment via trial and error by using feedback from its own actions and experiences. Reinforcement learning uses rewards and punishments as signals to indicate, during the training phase of a machine learning model, positive and negative behaviors of the agent. One salient goal of reinforcement learning is to discover a suitable machine learning model that maximizes the total cumulative reward of or associated with the agent.

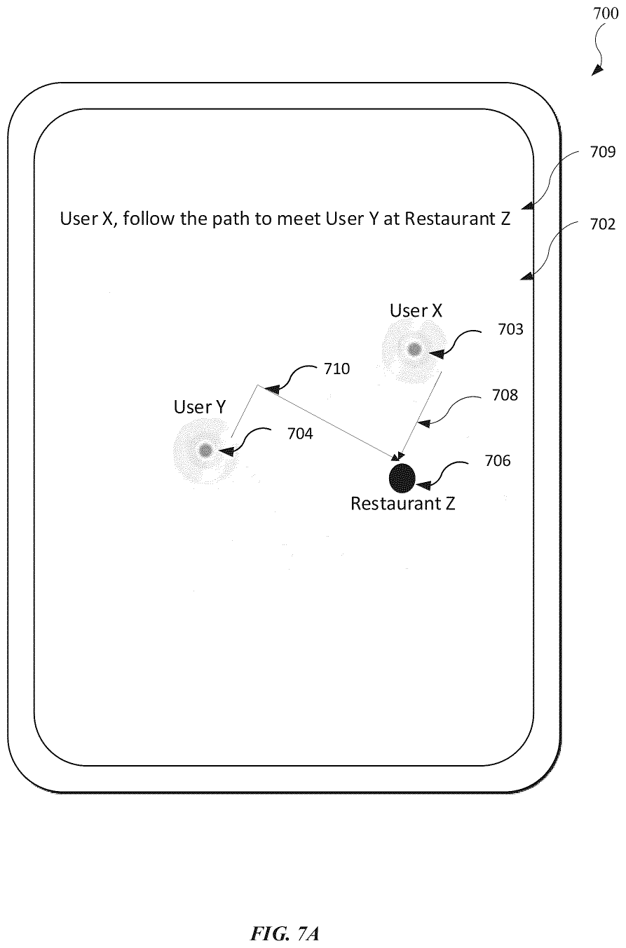

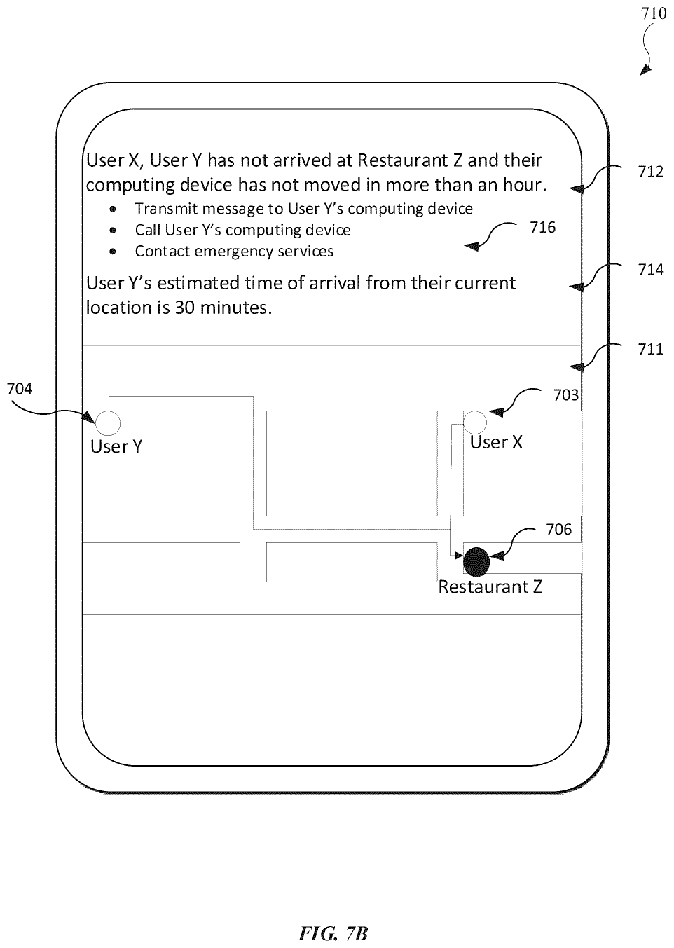

FIGS. 7A-7B illustrate an example user interfaces for enabling real-time location tracking and oversight for meetup participants, according to certain embodiments of this disclosure.

FIG. 7A illustrates user interface 700 that may be presented via the client application 104-1 on a first user's computing device 102-1. In some embodiments, the user interface 700 may be presented via the client 104-2 on a second user's computing device 102-2. The user interface 700 includes a graphical user interface displaying a map 702. As depicted, the map includes two icons 703 and 704 representing two users, User X and User Y, respectively. The icons 703 and 704 are placed on the map at their respective current locations of the user's computing devices 102-1 and 102-2. The current locations may be determined by a processing device based on tracking information including vehicle information, electronic device identifier information pertaining to one or more electronic devices, facial recognition information, other biometric information, global positioning system data, or some combination thereof. In some embodiments, the tracking information may be received by one or more devices (e.g., one or more cameras 120, one or more electronic device identification sensors 130) located at the license plate detection zone 122, the electronic device detection zone 132, and/or the facial detection zone 150.

To facilitate safer meetups between users, the user interface 700 may, as the two users move towards a meeting location (“Restaurant Z”) represented by icon 706, provide real-time tracking of both locations of the two users' computing devices 102-1 and/or 102-2. The location of the first user's computing device 102-1 is represented by icon 703 and the location of the second user's computing device 102-2 is represented by icon 704. Further, the server 118 may determine navigational guidance from the current location of the first user's computing device 102-1 to the meeting location, and the server 118 may also determine navigational guidance from the current location of the second user's computing device 102-2 to the meeting location.

The servers 118 may provide paths 708 and 710 representing the navigational guidance to be presented on the map 702 of the user interface 700. As depicted, the first user (User X) can follow the path 708 from the current location of icon 703 to the meeting location at icon 706. Further, the second user (User Y) can follow the path 710 from the current location of icon 704 to the meeting location at icon 706. As a proximity changes between the locations of the users' computing devices 102-1 and 102-2 (represented by icons 703 and 704), indications related to the proximity of the locations may be presented on the map 702. Further, as the locations of the users' computing devices 102-1 and 102-2 change, the navigational guidance may update directions that are provided via the user interface and/or audio. In some embodiments, the user interface 700 may include text 709 that provides instructions (e.g., “User X, follow the path to meet User Y at Restaurant Z”).

FIG. 7A illustrates user interface 710 that may be presented via the client application 104-1 on a first user's computing device 102-1. In some embodiments, the user interface 710 may be presented via the client application 104-2 on a second user's computing device 102-2. The user interface 700 includes a graphical user interface displaying a map 711. The map includes three icons: icon 703 representing a location of a first user's (“User X”) computing device, icon 704 representing a location of a second user's (“User Y”) computing device, and icon 706 representing a location of a meeting location (“Restaurant Z”).

In some embodiments of the present disclosure, the servers 118 of the cloud-based computing system 116 may perform oversight of a planned meetup. For example, the servers 118 may determine whether or not a computing device of a user (and, therefore, by implication, the user or that the user and the user's device have become separated) has strayed from a path specified by navigational guidance, whether or not a computing device of a user has stopped moving, whether or not a computing device of a user has powered down, and the like. Further, the servers 118 may continuously, continually, or periodically track the location of each computing device involved in a meetup and determine estimated times of arrivals to inform a user of when to expect to meet another user.

As depicted, the user interface 710 includes a statement 712 that indicates “User X, User Y has not arrived at Restaurant Z and their computing device has not moved in more than an hour.” Further, the user interface 710 provides a list of preventative actions 716 that User X may select to be executed. The list of preventative actions 716 includes (i) “Transmit message to User Y's computing device,” (ii) “Call User Y's computing device,” and (iii) “Contact emergency services.”

In addition, as depicted, the user interface 710 includes a statement that “User Y's estimated time of arrival from their current location is 30 minutes.” Such a statement may keep User X apprised of when to expect User Y to show up to the meeting location 706.

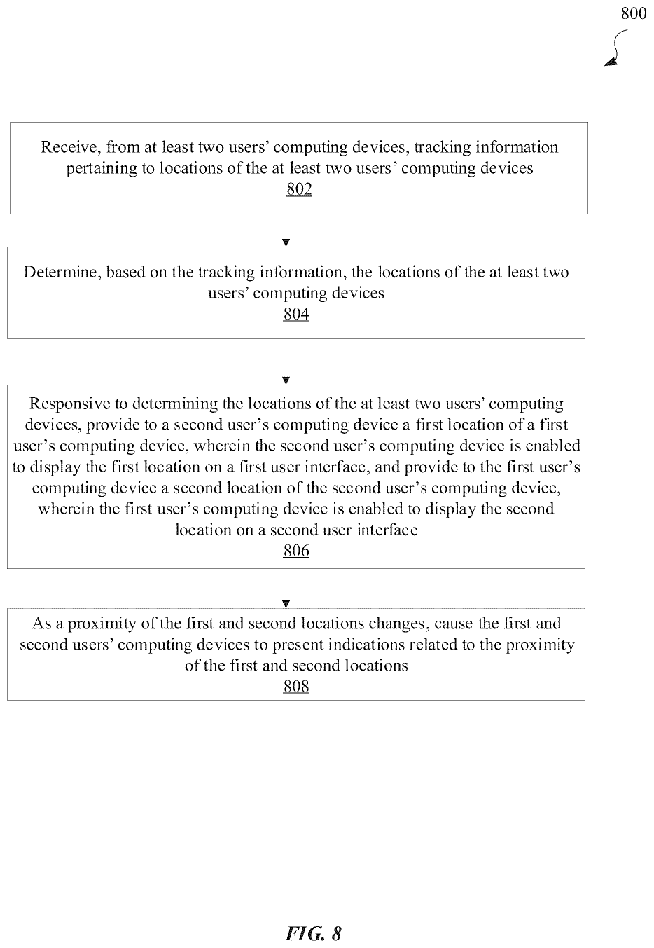

FIG. 8 illustrates an example method 800 for enabling real-time location tracking for users participating in meetups, according to certain embodiments of this disclosure. The method 800 may be performed by processing logic that may include hardware (circuitry, dedicated logic, etc.), firmware, software (such as is run on a computer system or specialized dedicated machine), or a combination of both. The method 800 and/or each of their individual functions, subroutines, methods (as the term is used in object-oriented programming), or operations may be performed by one or more processing devices of one or more of the devices in FIG. 1A and/or FIG. 6 (e.g., computing device 102 (e.g., 102-1, 102-2, 102-3, 102-4), cameras 120, electronic device identification sensors 130, computing device 161, cloud-based computing system 116 including servers 118) implementing the method 800. For example, a computing system may refer to the computing device 102 or the cloud-based computing system 116. The method 800 may be implemented as computer instructions that, when executed by a processing device, execute the operations. In some embodiments, the method 800 may be performed by a single processing thread. Alternatively, the method 800 may be performed by two or more processing threads, each thread implementing one or more individual functions, routines, subroutines, methods (as the term is used in object-oriented programming), or operations of the method 800.

For simplicity of explanation, the method 800 is depicted and described as a series of operations. However, operations in accordance with this disclosure can occur in various orders or concurrently, and with other operations not presented and described herein. For example, the operations depicted in the method 800 may occur in combination with any other operation of any other method disclosed herein. Furthermore, not all illustrated operations may be required to implement the method 800 in accordance with the disclosed subject matter. In addition, those skilled in the art will understand and appreciate that the method 800 could alternatively be represented as a series of interrelated states via a state diagram or events.

In some embodiments, one or more machine learning models may be generated and trained by the artificial intelligence engine 640 and/or the training engine 630 to perform one or more of the operations of the methods described herein. For example, to perform the one or more operations, the processing device may execute the one or more machine learning models 632. In some embodiments, the one or more machine learning models 632 may be iteratively retrained to select different features capable of enabling optimization of output. The features that may be modified may include a number of nodes included in each layer of the machine learning models 632, an objective function executed at each node, a number of layers, various weights associated with outputs of each node, and the like.

In some embodiments, the processing device may analyze various user characteristics (e.g., demographics, psychographics, occupation, preferences, dating history, etc.) of a set of users and output recommended user matches. The processing device may execute a machine learning model 632 trained to output a recommended user match. The training engine 630 may train the machine learning model 632 using training data including labeled inputs (e.g., user characteristics, user preferences, dating history, user score, user metric, risk level, etc.) mapped to labeled outputs (e.g., user recommendations). A first user may be presented a set of user matches on a user interface of a client application 104-1 executing on the first user's computing device 102-1. The first user may select a second user to meetup. The second user may also be presented, on a user interface of the second user's computing device 102-2, with a list of user matches, and the second user may choose to meetup with the first user.

In some embodiments, prior to receiving any tracking information and based on the selection made during the user match process, the processing device may transmit a request to a first user's computing device 102-1 and/or a second user's computing device 102-2. The request may pertain to whether the first and second user desire to meet in-person at a date, a social interest or meetup group, a work event, a social event, a private event, a public event, or some combination thereof. In some embodiments, the processing device may receive an indication of an approved request form the first user's computing device 102-1 and the second user's computing device 102-2 for the at least two users to meet in-person at a date, a social interest or meetup group, a work event, a social event, a private event, a public event, or some combination thereof.

At block 802, the processing device may receive, from at least two users' computing devices 102-1 and 102-2, tracking information pertaining to locations of the at least two users' computing devices 102-1 and 102-2. In some embodiments, the tracking information may be received only after the indication of the approved request to meet is received from the first and second users' computing devices 102-1 and 102-2. If one or both of the users decline to meet, and an indication of a declined request is received by the processing device, then the tracking information may not be received by the processing device from either of the user's computing devices 102-1 and 102-2. In some embodiments, the tracking information may include vehicle information, electronic device identifier information pertaining to one or more electronic devices (e.g., smartwatch, key fob, smartphone, tablet, etc.), facial recognition information, other biometric information, or some combination thereof.

In some embodiments, the tracking information may be received based on a scheduled date and time. For example, if the two users agreed to a date at a restaurant at 7:00 p.m. on a Friday, then the tracking information may be received at a certain time prior to the scheduled date and time to enable the two users to arrive at the restaurant around 7:00 p.m. on Friday. The certain time at which the tracking information is received may be based on numerous factors (e.g., a distance of each of the computing devices 102-1 and 102-2 from the restaurant, traffic patterns, weather patterns, crime statistics in areas between the computing devices 102-1 and 102-2 and the restaurant, or some combination thereof).

At block 804, the processing device may determine, based on the tracking information, the locations of the at least two users' computing devices 102-1 and 102-2. In some embodiments, the processing device may determine a geographical relationship between (i) each of the locations of the at least two users' computing devices 102-1 and 102-2 and (ii) a meeting location. For example, to determine the geographical relationship, the processing device may use global positioning system information pertaining to the at least two users' computing devices 102-1 and 102-2 and/or the meeting location. The meeting location may be specified by each of the two users once they each have approved the request to meet. Additionally, in some embodiments, a meeting date and time may be specified by each of the two users when they each have approved the request to meet.

In some embodiments, the processing device may execute a trained machine learning model to output a recommended meeting location, a recommended meeting date and time, or some combination thereof. In some embodiments, based on inputs including user characteristics, user preferences, location characteristics, crime statistics related to locations, or some combination thereof, one or more machine learning models 632 may be trained. For example, the training engine 630 may use training data including labeled inputs (e.g., user characteristics, user preferences, location characteristics, crime statistics related to locations, etc.) mapped to labeled outputs (e.g., recommended meeting location, recommended meeting date and time, etc.) to train the one or more machine learning models 604.

At block 806, responsive to determining the locations of the at least two users' computing devices 102-1 and 102-2, the processing device may provide to the second user's computing device 102-2 a first location of the first user's computing device 102-1. The second user's computing device 102-2 may be enabled to display the first location on a first user interface. The processing device may provide to the first user's computing device 102-1 a second location of the second user's computing device 102-2. The first user's computing device 102-1 may be enabled to display the second location on a second user interface. The processing device may determine navigational guidance between the first user's computing device 102-1 and the meeting location and between the second user's computing device 102-2 and the meeting location. The determination may be based on the geographical relationship between and among the first user's computing device 102-1, the second user's computing device 102-2, and the meeting location. The navigational guidance may be presented on the user interface of each user's respective computing device 102-1 and 102-2. In some embodiments, the user interfaces of the first and second users' computing devices 102-1 and 102-2 may concurrently present (i) a path between the second user's computing device and the meeting location and (ii) a path between the first user's computing device and the meeting location. That is, real-time tracking information may be presented on both users' computing devices 102-1 and 102-2 to provide assurances to each user that they are meeting up with the person they agreed to meet. Further, such techniques, may deter undesirable individuals from participating in meetups.

At block 808, as the proximity of the first and second locations changes (e.g., as the users move toward the meeting location with their respective computing devices 102-1 and 102-2), the processing device may cause the first and second users' computing devices to present indications related to the proximity of the first and second locations. The term “proximity,” as used herein, may refer, without limitation, to measures of distance, presence within a predefined area, changes in distance that are substantially significant, nearness in space, time, or relationship, etc. In some embodiments, the processing device may cause the first and second users' computing devices 102-1 and 102-2 to present the indications on a respective graphical user interface displaying a map. In some embodiments, the processing device may cause the first and second users' computing devices 102-1 and 102-2 to present the indications as respective icons on the respective graphical user interfaces displaying the map.

In some embodiments, the icons may be visually modified based on a determined state of the users' computing device 102-1 and 102-2. For example, if the computing devices 102-1 and 102-2 are correctly following a path provided by the navigational guidance, the icons may be presented as a certain color (e.g., green) on the graphical user interface. In another example, if the computing devices 102-1 and 102-2 deviate from the path provided by the navigational guidance, the icons may be presented as a different color (e.g., red) on the graphical user interface. In another example, one of the icons representing the computing device 102-1 may be presented as a certain color (e.g., orange) if the computing device 102-1 stops moving or delays at a certain location for more than a threshold period of time.

In some embodiments, based on where each of the computing devices 102-1 and 102-2 is located, the processing device may determine an estimated time of arrival for each of the computing devices 102-1 and 102-2 to the meeting location. To enable the users to determine when the other user will arrive at the meeting location, the processing device may present the estimated time of arrival of each of the computing devices 102-1 and 102-2 on each of the respective user interfaces of the computing devices 102-1 and 102-2.

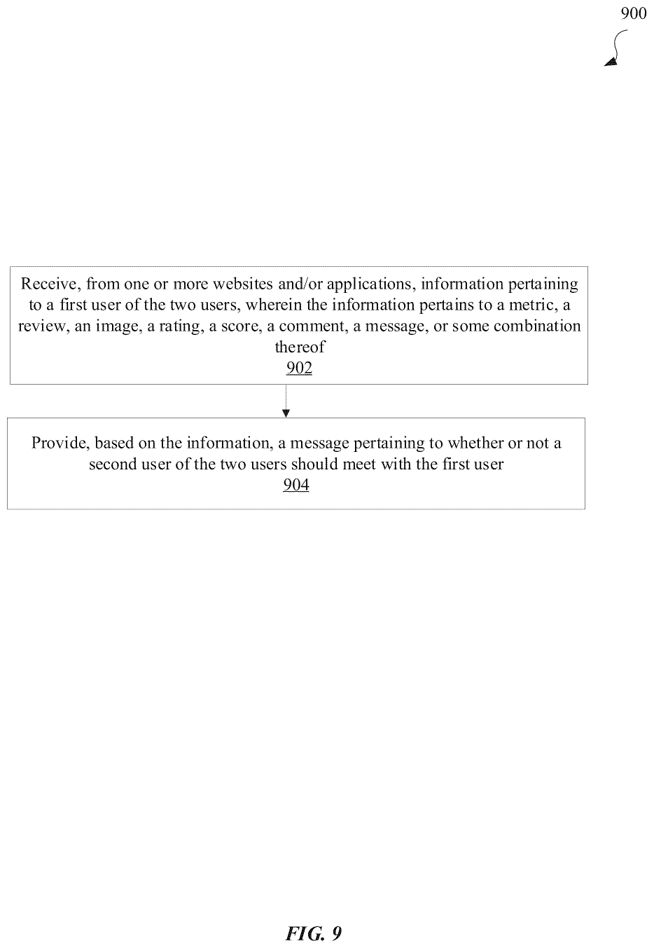

In some embodiments, the processing device may transmit, based on information about the first user, a warning message to the second user's computing device 102-2. For example, and as described further below with reference to FIG. 9, the processing device may continually, continuously, or periodically monitor information pertaining to each of the users who have agreed to meetup. In some embodiments, when agreeing to terms and services, each of the users may have provided permission for each of their respective information to be monitored. If the information about one of the users is undesirable, then the processing device may alert the other user about the undesirable nature of the information. In one illustrative example, two users may be dating for a period of time, and a first user may be arrested, which results in a police report's being filed. The processing device may obtain the police report from a source (e.g., Internet) and transmit a warning message to a second user who is dating the first user. The warning message may indicate that the first user was recently arrested and may provide the police report.

FIG. 9 illustrates an example method 900 for providing a message pertaining to whether or not users should meet, according to certain embodiments of this disclosure. The method 900 may be performed by processing logic that may include hardware (circuitry, dedicated logic, etc.), firmware, software (such as is run on a computer system or specialized dedicated machine), or a combination of both. The method 900 and/or each of its individual functions, subroutines, methods (as the term is used in object-oriented programming), or operations may be performed by one or more processing devices of one or more of the devices in FIG. 1A and/or FIG. 6 (e.g., computing device 102 (e.g., 102-1, 102-2, 102-3, 102-4), cameras 120, electronic device identification sensors 130, computing device 161, cloud-based computing system 116 including servers 118) implementing the method 900. For example, a computing system may refer to the computing device 102 or the cloud-based computing system 116. The method 900 may be implemented as computer instructions that, when executed by a processing device, execute the operations. In some embodiments, the method 900 may be performed by a single processing thread. Alternatively, the method 900 may be performed by two or more processing threads, each thread implementing one or more individual functions, routines, subroutines, methods (as the term is used in object-oriented programming), or operations of the method 900. Method 900 may be performed in a manner similar to method 800's.

At block 902, the processing device may receive, from one or more websites and/or applications, information pertaining to a first user of the two users. The information may pertain to a metric, a review, an image, a rating, a score, a comment, a message, or some combination thereof. For example, certain dating websites provide feedback on the users of the websites, ratings on the users of the websites, and the like. The processing device may use screen scraping techniques to obtain the information from various websites and/or applications with which the users and/or members are associated. In some embodiments, the processing device may be communicatively coupled to one or more application programming interfaces of the websites and/or applications, and may execute function calls to obtain the information pertaining to the users of the websites and/or applications.

At block 904, the processing device may provide, based on the information, a message pertaining to whether or not a second user of the two users should meet with the first user. For example, if the first user has a rating of 1.5 out of 5, where 1 is the lowest rating and 5 is the highest rating, then the processing device may provide a message that warns the second user not to go on a date with the first user or suggests to the second user that a date with the first user is not advisable. The processing device may transmit the message via the network 102 to the second user's computing device 102-2. The second user's computing device 102-2 may present the message (e.g., as a push notification) on a user interface.

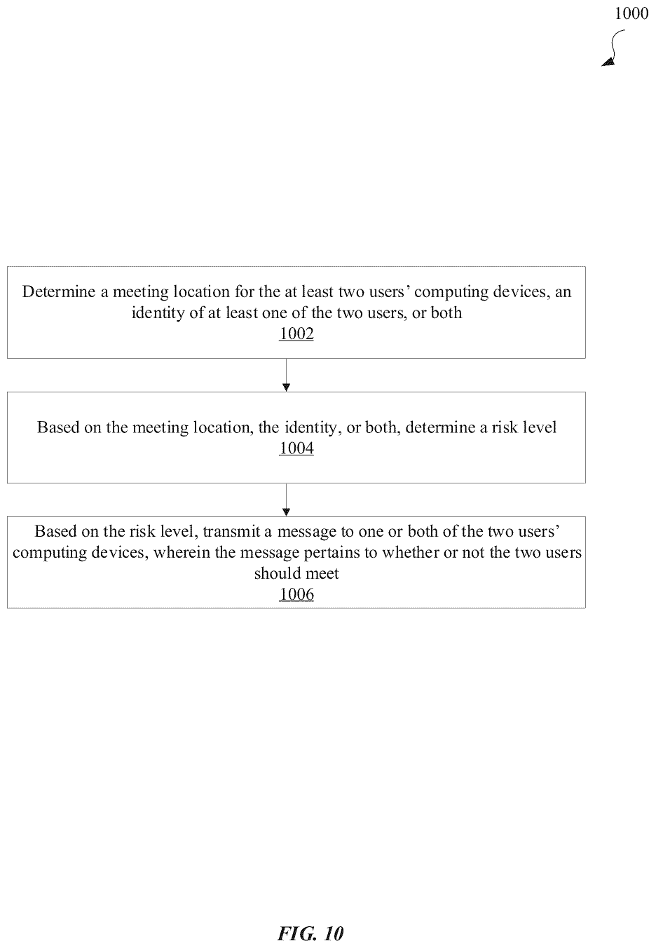

FIG. 10 illustrates an example method 1000 for transmitting, based on a risk level, a message pertaining to whether or not users should meet, according to certain embodiments of this disclosure. The method 1000 may be performed by processing logic that may include hardware (circuitry, dedicated logic, etc.), firmware, software (such as is run on a computer system or specialized dedicated machine), or a combination of both. The method 1000 and/or each of its individual functions, subroutines, methods (as the term is used in object-oriented programming), or operations may be performed by one or more processing devices of one or more of the devices in FIG. 1A and/or FIG. 6 (e.g., computing device 102 (e.g., 102-1, 102-2, 102-3, 102-4), cameras 120, electronic device identification sensors 130, computing device 161, cloud-based computing system 116 including servers 118) implementing the method 1000. For example, a computing system may refer to the computing device 102 or the cloud-based computing system 116. The method 1000 may be implemented as computer instructions that, when executed by a processing device, execute the operations. In some embodiments, the method 1000 may be performed by a single processing thread. Alternatively, the method 1000 may be performed by two or more processing threads, each thread implementing one or more individual functions, routines, subroutines, methods (as the term is used in object-oriented programming), or operations of the method 1000. Method 1000 may be performed in a manner similar to method 800's.

At block 1002, the processing device may determine a meeting location for the at least two users' computing devices 102-1 and 102-2, may determine an identity of at least one of the two users, or both. The meeting location may be obtained by searching a digital map for an address associated with the meeting. The identities of the users may be obtained from respective user profiles, social network profiles, occupation websites, search engines, and the like.

At block 1004, based on the meeting location, the identity, or both, the processing device may determine a risk level for meeting. The risk level may be determined subsequent to two users determining to meetup. In some embodiments, only one user may determine to attend an event, for example. In such a case, the processing device may determine the risk level for the user if the user intends to attend that event. The processing device may consider numerous factors pertaining to the event (e.g., event location, crime statistics of the event location, other users attending the event, criminal histories of the other users, time and date, weather, etc.) when assessing the risk level for attending the event.

In some embodiments, one or more machine learning models 632 may be trained to output the risk level. The training engine 630 may use training data including labeled inputs (e.g., meeting locations, crime statistics associated with the meeting locations, user characteristics, criminal records of users, time and date, weather, etc.) mapped to labeled outputs (e.g., risk levels) to train the one or more machine learning models 632.

At block 1006, based on the risk level, the processing device may transmit a message to one or both of the two users' computing devices 102-1 and 102-2. The message may pertain to whether or not the two users should meet. The message may be presented on a user interface of the users' computing devices 102-1 and/or 102-2.

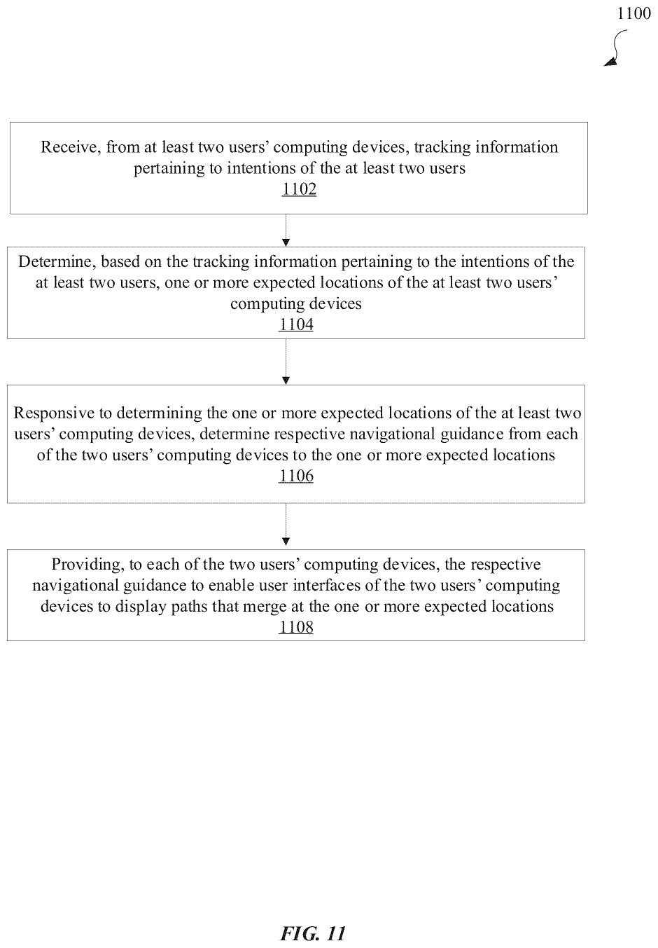

FIG. 11 illustrates an example method 1100 for facilitating, based on intentions of users, navigational guidance to one or more expected meeting locations, according to certain embodiments of this disclosure. The method 1100 may be performed by processing logic that may include hardware (circuitry, dedicated logic, etc.), firmware, software (such as is run on a computer system or specialized dedicated machine), or a combination of both. The method 1100 and/or each of its individual functions, subroutines, methods (as the term is used in object-oriented programming), or operations may be performed by one or more processing devices of one or more of the devices in FIG. 1A and/or FIG. 6 (e.g., computing device 102 (e.g., 102-1, 102-2, 102-3, 102-4), cameras 120, electronic device identification sensors 130, computing device 161, cloud-based computing system 116 including servers 118) implementing the method 1100. For example, a computing system may refer to the computing device 102 or the cloud-based computing system 116. The method 1100 may be implemented as computer instructions that, when executed by a processing device, execute the operations. In some embodiments, the method 1100 may be performed by a single processing thread. Alternatively, the method 1100 may be performed by two or more processing threads, each thread implementing one or more individual functions, routines, subroutines, methods (as the term is used in object-oriented programming), or operations of the method 1100. Method 1100 may be performed in a manner similar to method 800's.

At block 1102, the processing device may receive, from at least two users' computing devices 102-1 and 102-2, tracking information pertaining to the intentions of the at least two users. In some embodiments, the tracking information pertaining to the intentions may be determined from a calendar application, an electronic mail message, a text message, a voicemail, a search engine query, a web browser history, a location history of at least one of the two users' computing devices, or some combination thereof. For example, a first user may use his computing device 102-1 to transmit a message to a second user's computing device 102-2, where the message indicates “Hey Tom, I will meet you tomorrow at 7:00 p.m. at Joe's Steakhouse.” The processing device may process the text message to determine the users' intentions are to meet tomorrow at 7:00 p.m. at Joe's Steakhouse.

At block 1104, the processing device may determine, based on the tracking information pertaining to the intentions of the at least two users, one or more expected locations of the at least two users' computing devices 102-1 and 102-2. The processing device may use the text message as tracking information to determine the users intend to meet at Joe's Steakhouse's location tomorrow at 7:00 p.m.

At block 1106, responsive to determining the one or more expected locations of the at least two users' computing devices 102-1 and 102-2, the processing device may determine respective navigational guidance from each of the two users' computing devices 102-1 and 102-2 to the one or more expected locations. To determine the navigational guidance, the processing device may use global positioning system data associated with each of the computing devices 102-1 and 102-2 and one or more computing devices located at the one or more locations. The navigational guidance may include one or more paths from the computing device 102-1 to the one or more locations, and may include one or more paths from the computing device 102-2 to the one or more locations. The navigational guidance may include turn-by-turn instructions specifying a path or paths for the computing devices 102-1 and 102-2 from their current locations to the one or more expected locations.

In some embodiments, the processing device may execute one or more machine learning models 632 to predict, based on the tracking information, the one or more expected locations of the at least two users' computing devices 102-1 and 102-2. The one or more machine learning models 632 may be trained by the training engine 630. The training engine 630 may use training data, including labeled inputs (e.g., tracking information pertaining to calendar information, text messages, electronic mail messages, event information, web browser history, search engine history, location history, etc.) mapped to labeled outputs (e.g., expected locations), to train the machine learning models 632.

At block 1108, the processing device may provide, to each of the two users' computing devices 102-1 and 102-2, the respective navigational guidance to enable user interfaces of the two users' computing devices 102-1 and 102-2 to display paths that merge, meet and/or intersect at the one or more expected locations. That is, the computing device 102-1 may concurrently present, on a user interface, a path from the computing device's 102-1 location to the one or more expected locations and from the computing device's 102-2 location to the one or more expected locations. Further, the computing device 102-2 may also concurrently present, on a user interface, a path from the computing device's 102-1 location to the one or more expected locations and from the computing device's 102-2 location to the one or more expected locations. In some embodiments, as a proximity of locations of the two users' computing devices 102-1 and 102-2 changes, the processing device may cause the user interface to modify the navigational guidance by providing updated directions to the user on or via the user's respective computer device.

In some embodiments, the processing device may determine, based on the tracking information pertaining to the intentions of the at least two users, a date and time of a meeting at the one or more expected locations. For example, the processing device may process the message that indicates “Hey Tom, I will meet you tomorrow at 7:00 p.m. at Joe's Steakhouse” to determine that the date is tomorrow's date and that the meeting time is 7:00 p.m. . . . In some embodiments, based on the date and time of the meeting at the one or more expected locations, the processing device may provide, to each of the two users' computing devices 102-1 and 102-2, the respective navigational guidance. For example, the processing device may determine an estimated time of arrival for each of the computing devices 102-1 and 102-2 to arrive at the expected location from the current location of each of the computing devices 102-21 and 102-2, wherein the arrival of any given computing device serves as a proxy to represent the arrival of the user to whom the computing device belongs, such proxy use to apply in any similar context used elsewhere herein. The processing device may use the estimated time of arrival to determine when to provide the navigational guidance to the computing devices 102-1 and 102-2. The determination may enable the users to leave their current locations at a certain time in order to arrive at the expected location at or before the estimated time of arrival.

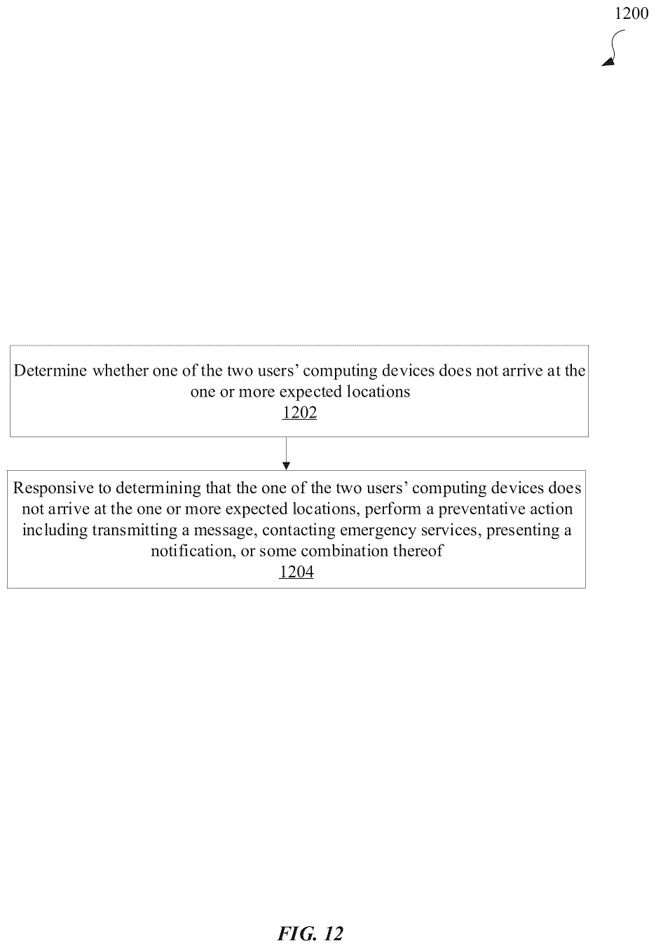

FIG. 12 illustrates an example method 1200 for performing a preventative action when a computing device does not arrive at an expected location, according to certain embodiments of this disclosure. The method 1200 may be performed by processing logic that may include hardware (circuitry, dedicated logic, etc.), firmware, software (such as is run on a computer system or specialized dedicated machine), or a combination of both. The method 1200 and/or each of its individual functions, subroutines, methods (as the term is used in object-oriented programming), or operations may be performed by one or more processing devices of one or more of the devices in FIG. 1A and/or FIG. 6 (e.g., computing device 102 (e.g., 102-1, 102-2, 102-3, 102-4), cameras 120, electronic device identification sensors 130, computing device 161, cloud-based computing system 116 including servers 118) implementing the method 1200. For example, a computing system may refer to the computing device 102 or the cloud-based computing system 116. The method 1200 may be implemented as computer instructions that, when executed by a processing device, execute the operations. In some embodiments, the method 1200 may be performed by a single processing thread. Alternatively, the method 1200 may be performed by two or more processing threads, each thread implementing one or more individual functions, routines, subroutines, methods (as the term is used in object-oriented programming), or operations of the method 1200. Method 1200 may be performed in a manner similar to method 800's.

At block 1202, the processing device may determine whether one of the two users' computing devices 102-1 and 102-2 does not arrive at the one or more expected locations. The processing device may implement a time window of acceptable times for the two users' computing devices 102-1 and 102-2 to arrive at the one or more expected locations. In some embodiments, the processing device may implement a geofence (e.g., virtual perimeter or boundary) around the one or more expected locations, and the computing devices 102-1 and 102-2 may be determined to have arrived when they enter the geofence. The processing device may using global positioning system data to determine precise locations of the computing devices 102-1 and 102-2 in relation to the expected locations. If one of the two user's computing devices 102-1 and 102-2 do not arrive within the geofence or at the expected location within the time window, then the processing device may determine that there is a potential concern regarding the location and/or safety of the user associated with the respective computing device.

At block 1204, responsive to determining that the one of the two users' computing devices does not arrive at the one or more expected locations, the processing device may perform one or more preventative actions. The preventative actions may include transmitting a message, contacting emergency services, presenting a notification, or some combination thereof. For example, the processing may transmit a text message to the computing device 102-1 and/or 102-2 of the user who is determined to have not arrived at the one or more expected locations. In some embodiments, the processing device may initiate a phone call with the computing device 102-1 and/or 102-2.

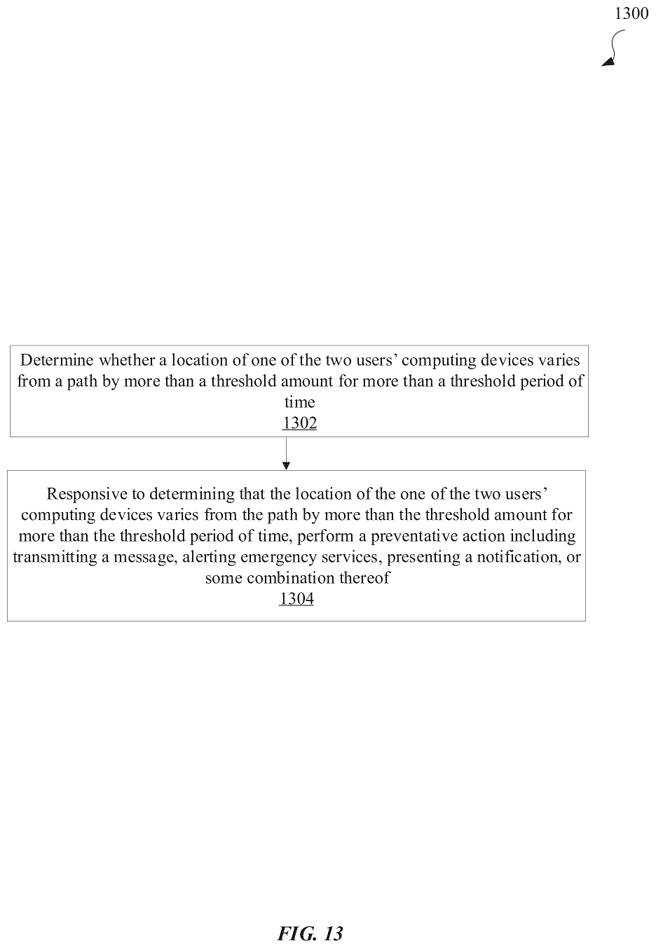

FIG. 13 illustrates an example method 1300 for performing a preventative action when a computing device varies from a path, according to certain embodiments of this disclosure. The method 1300 may be performed by processing logic that may include hardware (circuitry, dedicated logic, etc.), firmware, software (such as is run on a computer system or specialized dedicated machine), or a combination of both. The method 1300 and/or each of its individual functions, subroutines, methods (as the term is used in object-oriented programming), or operations may be performed by one or more processing devices of one or more of the devices in FIG. 1A and/or FIG. 6 (e.g., computing device 102 (e.g., 102-1, 102-2, 102-3, 102-4), cameras 120, electronic device identification sensors 130, computing device 161, cloud-based computing system 116 including servers 118) implementing the method 1300. For example, a computing system may refer to the computing device 102 or the cloud-based computing system 116. The method 1300 may be implemented as computer instructions that, when executed by a processing device, execute the operations. In some embodiments, the method 1300 may be performed by a single processing thread. Alternatively, the method 1300 may be performed by two or more processing threads, each thread implementing one or more individual functions, routines, subroutines, methods (as the term is used in object-oriented programming), or operations of the method 1300. Method 1300 may be performed in a manner similar to method 800's.

At block 1302, the processing device may determine whether a location of one of the two users' computing devices 102-1 and 102-2 varies from a path by more than a threshold amount, wherein the threshold amount continues for more than a threshold period of time.

At block 1304, responsive to determining that the location of the one of the two users' computing devices 102-1 and 102-2 varies from the path by more than the threshold amount for more than the threshold period of time, the processing device may perform one or more preventative actions. The preventative actions may include transmitting a message, contacting emergency services, presenting a notification, or some combination thereof. For example, the processing may transmit a text message to the computing device 102-1 and/or 102-2 of the user that the location of one of the two users' computing devices 102-1 and 102-2 has varied from the path by more than the threshold amount for more than the threshold period of time. In some embodiments, the processing device may initiate a phone call with the computing device 102-1 and/or 102-2.

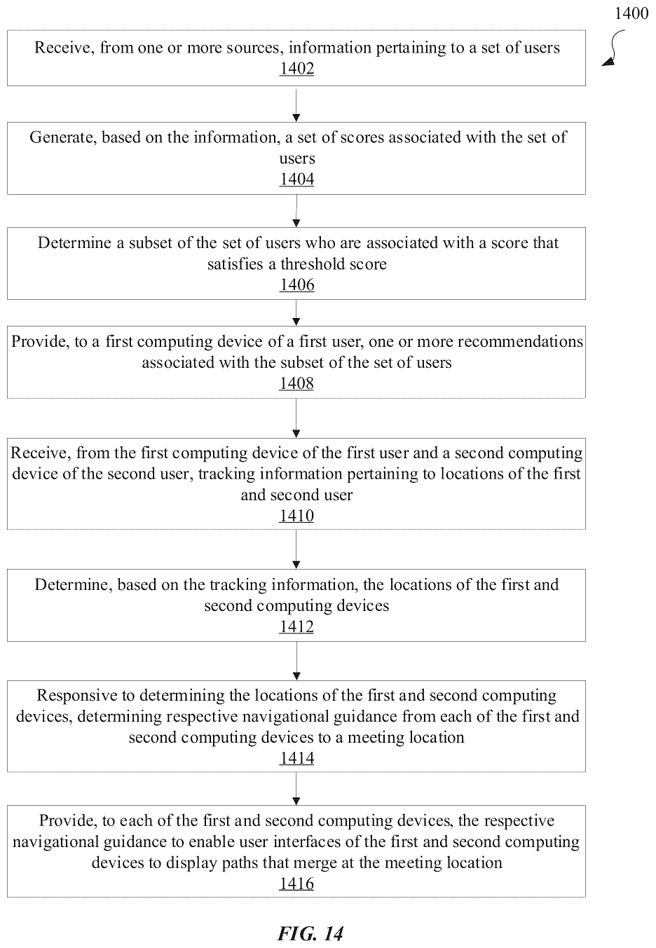

FIG. 14 illustrates an example method 1400 providing, based on one or more scores, a recommendation associated with a subset of users, according to certain embodiments of this disclosure. The method 1400 may be performed by processing logic that may include hardware (circuitry, dedicated logic, etc.), firmware, software (such as is run on a computer system or specialized dedicated machine), or a combination of both. The method 1400 and/or each of its individual functions, subroutines, methods (as the term is used in object-oriented programming), or operations may be performed by one or more processing devices of one or more of the devices in FIG. 1A and/or FIG. 6 (e.g., computing device 102 (e.g., 102-1, 102-2, 102-3, 102-4), cameras 120, electronic device identification sensors 130, computing device 161, cloud-based computing system 116 including servers 118) implementing the method 1400. For example, a computing system may refer to the computing device 102 or the cloud-based computing system 116. The method 1400 may be implemented as computer instructions that, when executed by a processing device, execute the operations. In some embodiments, the method 1400 may be performed by a single processing thread. Alternatively, the method 1400 may be performed by two or more processing threads, each thread implementing one or more individual functions, routines, subroutines, methods (as the term is used in object-oriented programming), or operations of the method 1400. Method 1400 may be performed in manner similar to method 800's.

At block 1402, the processing device may receive, from one or more sources, information pertaining to a set of users. In some embodiments, the one or more sources may include a website (e.g., social networking websites, company websites, chat forums, online marketplace websites, content-sharing websites, blogs, etc.), an application (e.g., messaging applications, gaming applications, etc.), a computing device (e.g., smartphones, smartwatches, etc.), or some combination thereof. The information may include feedback about the users, ratings associated with the users, comments pertaining to the users, messages sent by the users, social media posts made by the users, metrics about the users, content shared by the users, content liked by the users, content disliked by the users, purchases made by the users, and the like. The content may refer to any suitable multimedia, such as images, video, audio, podcasts, and the like.

At block 1404, the processing device may generate, based on the information, a set of scores associated with the set of users. In some embodiments, one or more machine learning models 632 may be trained to generate, based on the information, the set of scores associated with the set of users. In some embodiments, the training engine 630 may use training data including labeled inputs (e.g., information including feedback about the users, ratings associated with the users, comments pertaining to the users, messages sent by the users, social media posts made by the users, metrics about the users, content shared by the users, content liked by the users, content disliked by the users, purchases made by the users, etc.) mapped to labeled outputs (e.g., scores for users) to train the one or more machine learning models 632.

At block 1406, the processing device may determine a subset of the set of users who are associated with a score that satisfies a threshold score. The threshold score may include any suitable value and/or scale. For example, on a scale of 1 to 5, where 1 is the lowest score and 5 is the highest score, the threshold score may be configured to be 3. Anything equal to or above a score of 3 is, in this example, deemed to satisfy the threshold score.

At block 1408, the processing device may provide, to a first computing device 102-1 of a first user, one or more recommendations associated with the subset of the set of users. The recommendations may include recommended users from the subset that the user should contact and/or meet up with.

At block 1410, the processing device may receive, from the first computing device 102-1 of the first user and a second computing device 102-2 of the second user, tracking information pertaining to locations of the first and second users' computing devices 102-1 and 102-2. In some embodiments, the tracking information may include vehicle information, electronic device identifier information pertaining to one or more electronic devices, facial recognition information, other biometric information, or some combination thereof. In some embodiments, the tracking information may include global positioning system data associated with the users' computing devices 102-1 and 102-2.

At block 1412, the processing device may determine, based on the tracking information, the locations of the first and second computing devices 102-1 and 102-2. In some embodiments, the processing device may receive the tracking information from the license plate detection zone 122, the electronic device detection zone 132, and/or the facial detection zone 150. Based on known locations, coordinates, and/or geographical positions of the license plate detection zone 122, the electronic device detection zone 132, and/or the facial detection zone 150, the processing device may determine the locations of the first and second computing devices 102-1 and 102-2.

At block 1414, responsive to determining the locations of the first and second computing devices 102-1 and 102-2, the processing device may determine respective navigational guidance from each of the first and second computing devices 102-1 and 102-2 to a meeting location. In some embodiments, one or more machine learning models 632 may be trained to recommend the meeting location. When the users are selecting to meet during the matching phase. the machine learning models 632 may recommend the meeting location to the users. The training engine 630 may train the one or more machine learning models 632 by using training data including labeled inputs (e.g., user characteristics, user preferences, location characteristics, crime statistics related to locations, weather, traffic, date and time, event schedules, etc.) mapped to labeled outputs (e.g., meeting locations).

At block 1416, the processing device may provide, to each of the first and second computing devices 102-1 and 102-2, the respective navigational guidance to enable user interfaces of the first and second computing devices 102-1 and 102-2 to display paths that merge, meet and/or intersect at the meeting location. In some embodiments, as a proximity of locations of the first and second computing devices 102-1 and 102-2 changes, the processing device may cause the user interfaces of the computing devices 102-1 and 102-2 to modify the navigational guidance by updating the directions that are provided.

In some embodiments, to determine a risk level of meeting at the meeting location, the processing device may execute the one or more machine learning models 632. The risk level may be determined based on a number of factors including criminal records of users at the meeting location, crime statistics of the area surrounding the meeting location, the time and day of the meeting, the criminal record of the users meeting, predicted weather at the time of the meeting, predicted traffic around the time of the meeting, and the like. The machine learning models 632 may be trained to use these factors as inputs and, then, to output the risk level. If the risk level is above a risk threshold level (e.g., the meeting location is too risky), then the processing device may provide a recommendation to meet at another meeting location. If the risk level is below the risk threshold level (e.g., the meeting location is safe), then the processing device may provide an indication that the meeting location is safe.

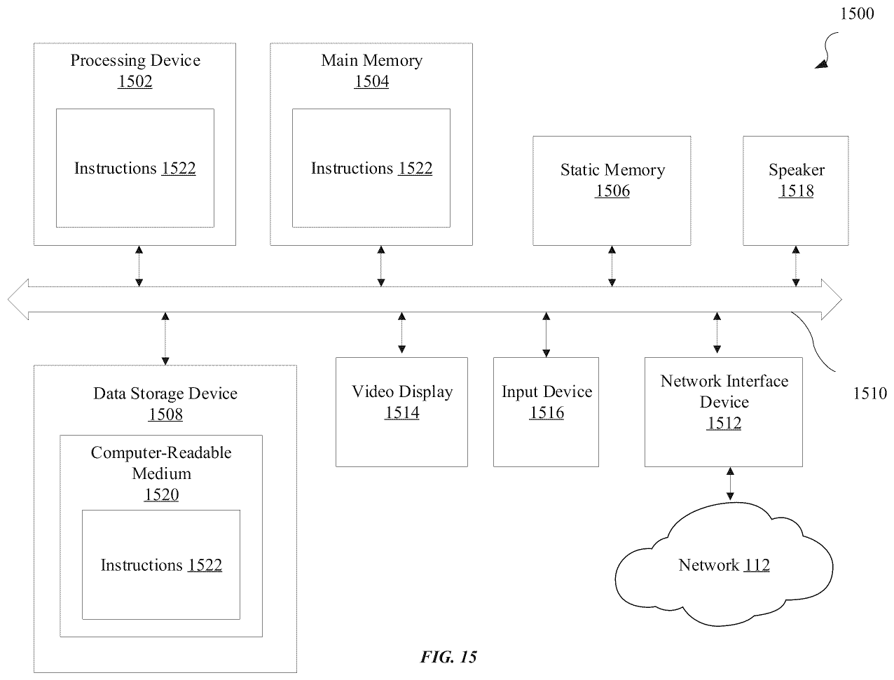

FIG. 15 illustrates example computer system 1500 which can perform any one or more of the methods described herein, in accordance with one or more aspects of the present disclosure. In one example, computer system 1500 may correspond to the computing device 102 (e.g., 102-1, 102-2, 102-3, 102-4), server 118 of the cloud-based computing system 116, the cameras 120, the electronic device identification sensors 130, the computing device 161, and/or the training engine 630 of FIG. 1A and FIG. 6. The computer system 1500 may be capable of executing client application 104 (e.g., 104-1, 104-2), website 606, and/or application 608 of FIG. 1A and FIG. 6. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a wearable (e.g., wristband, smartwatch, necklace, anklet, etc.), a set-top box (STB), a personal Digital Assistant (PDA), a mobile phone, a camera, a video camera, an electronic device identification sensor, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1500 includes a processing device 1502, a main memory 1504 (e.g., read-only memory (ROM), flash memory, dynamic random access memory (DRAM) such as synchronous DRAM (SDRAM)), a static memory 1506 (e.g., solid state drive (SSD), flash memory, static random access memory (SRAM)), and a data storage device 1508, which communicate with each other via a bus 1510.

Processing device 1502 represents one or more general-purpose processing devices such as a microprocessor, central processing unit, or the like. More particularly, the processing device 1502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1502 may also be one or more special-purpose processing devices such as an application specific integrated circuit (ASIC), a field programmable gate array (FPGA), a digital signal processor (DSP), network processor, or the like. The processing device 1502 is configured to execute instructions for performing any of the operations and steps discussed herein.

The computer system 1500 may further include a network interface device 1512 communicatively coupled to the network 112. The computer system 1500 also may include a video display 1514 (e.g., a liquid crystal display (LCD) or a cathode ray tube (CRT)), one or more input devices 1516 (e.g., a keyboard and/or a mouse), and one or more speakers 1518 (e.g., a speaker). In one illustrative example, the video display 1514 and the input device(s) 1516 may be combined into a single component or device (e.g., an LCD touch screen).

The data storage device 1516 may include a computer-readable medium 1520 on which the instructions 1522 (e.g., implementing control system, user portal, clinical portal, and/or any functions performed by any device and/or component depicted in the FIGURES and described herein) embodying any one or more of the methodologies or functions described herein is stored. The instructions 1522 may also reside, completely or at least partially, within the main memory 1504 and/or within the processing device 1502 during execution thereof by the computer system 1500. As such, the main memory 1504 and the processing device 1502 also constitute computer-readable media. The instructions 1522 may further be transmitted or received over a network 112 via the network interface device 1512.

While the computer-readable storage medium 1520 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In addition to providing notifications as described above, the present disclosure may provide notification of suspicious people in public spaces. For example, the present disclosure may enable the provision of notifications to relevant users and/or authorities, including law enforcement and private security, of criminals in subways. In addition, given the high correlation of people who jump turnstiles in public transportation networks and people with outstanding warrants, the present disclosure may detect people jumping turnstiles and notify law enforcement and/or private security. As a further example, the preset disclosure may provide notifications of intrusion in restricted areas of a hospital.

Consistent with the above disclosure, the examples of systems and method enumerated in the following clauses are specifically contemplated and are intended as a non-limiting set of examples.

Clause 1. A computer-implemented method comprising:
receiving, from at least two users' computing devices, tracking information pertaining to locations of the at least two users' computing devices;
determining, based on the tracking information, the locations of the at least two users' computing devices;
responsive to determining the locations of the at least two users' computing devices, providing to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface; and
as a proximity of the first and second locations changes, causing the first and second users' computing devices to present indications related to the proximity of the first and second locations.

Clause 2. The computer-implemented method of any clause herein, further comprising, prior to receiving the tracking information:
(i) transmitting a request to the first user's computing device and the second user's computing device, wherein the request pertains to whether the first and second user desire to meet in-person, and
(ii) receiving an indication of an approved request from the first user's computing device and the second user's computing device for the at least two users to meet in-person.

Clause 3. The computer-implemented method of any clause herein, wherein the request pertains to at least one of a date, a social interest or meetup group, a work event, a social event, a private event, a public event, or some combination thereof.

Clause 4. The computer-implemented method of any clause herein, further comprising causing the first and second users' computing devices to present the indications on a respective graphical user interface displaying a map.

Clause 5. The computer-implemented method of any clause herein, further comprising causing the first and second users' computing devices to present the indications as respective icons on the respective graphical user interfaces displaying the map.

Clause 6. The computer-implemented method of any clause herein, further comprising executing a trained machine learning model to output a recommended meeting location, a recommended meeting date and time, or some combination thereof, wherein, based on inputs comprising user characteristics, user preferences, location characteristics, crime statistics related to locations, or some combination thereof, the trained machine learning model is trained.

Clause 7. The computer-implemented method of any clause herein, further comprising executing a trained machine learning model to output a recommended user match, wherein the trained machine learning model is trained based on inputs comprising user characteristics, user preferences, dating history, or some combination thereof.

Clause 8. The computer-implemented method of any clause herein, wherein the tracking information comprises vehicle information, electronic device identifier information pertaining to one or more electronic devices, facial recognition information, other biometric information, or some combination thereof.

Clause 9. The computer-implemented method of any clause herein, wherein the tracking information is received based on a scheduled date and time.

Clause 10. The computer-implemented method of any clause herein, further comprising transmitting, based on information about the first user, a warning message to the second user's computing device.

Clause 11. The computer-implemented method of any clause herein, further comprising:
receiving, from one or more websites and/or applications, information pertaining to a first user of the two users, wherein the information pertains to a metric, a review, an image, a rating, a score, a comment, a message, or some combination thereof; and
providing, based on the information, a message pertaining to whether or not a second user of the two users should meet with the first user.

Clause 12. The computer-implemented method of any clause herein, further comprising:
determining a meeting location for the at least two users' computing devices, an identity of at least one of the two users, or both;

based on the meeting location, the identity, or both, determining a risk level; and based on the risk level, transmitting a message to one or both of the two users' computing devices, wherein the message pertains to whether or not the two users should meet.

Clause 13. A system comprising:
one or more memory devices storing instructions;
one or more processing devices communicatively coupled to the one or more memory devices, wherein the one or more processing devices execute the instructions to:
   receive, from at least two users' computing devices, tracking information pertaining to locations of the at least two users' computing devices;
   determine, based on the tracking information, the locations of the at least two users' computing devices;
   responsive to determining the locations of the at least two users' computing devices, provide to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface; and
   as a proximity of the first and second locations changes, cause the first and second users' computing devices to present indications related to the proximity of the first and second locations.

Clause 14. The system of any clause herein, wherein, prior to receiving the tracking information, the one or more processing devices:
(i) transmit a request to the first user's computing device and the second user's computing device, wherein the request pertains to whether the first and second user desire to meet in-person, and
(ii) receive an indication of an approved request from the first user's computing device and the second user's computing device for the at least two users to meet in-person.

Clause 15. The system of any clause herein, wherein the request pertains to at least one of a date, a social interest or meetup group, a work event, a social event, a private event, a public event, or some combination thereof.

Clause 16. The system of any clause herein, wherein the one or more processing devices cause the first and second users' computing devices to present the indications on a respective graphical user interface displaying a map.

Clause 17. The system of any clause herein, wherein the one or more processing devices cause the first and second users' computing devices to present the indications as respective icons on the respective graphical user interfaces displaying the map.

Clause 18. The system of any clause herein, wherein the one or more processing devices execute a trained machine learning model to output a recommended meeting location, a recommended meeting date and time, or some combination thereof, wherein, based on inputs comprising user characteristics, user preferences, location characteristics, crime statistics related to locations, or some combination thereof, the trained machine learning model is trained.

Clause 19. The system of any clause herein, wherein the one or more processing devices execute a trained machine learning model to output a recommended user match, wherein the trained machine learning model is trained based on inputs comprising user characteristics, user preferences, dating history, or some combination thereof.

Clause 20. A tangible, non-transitory computer-readable medium storing instructions that, when executed, cause one or more processing devices to:
receive, from at least two users' computing devices, tracking information pertaining to locations of the at least two users' computing devices;
determine, based on the tracking information, the locations of the at least two users' computing devices;
responsive to determining the locations of the at least two users' computing devices, provide to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface; and
as a proximity of the first and second locations changes, cause the first and second users' computing devices to present indications related to the proximity of the first and second locations.

Clause 21. A computer-implemented method comprising:
receiving, from at least two users' computing devices, tracking information pertaining to intentions of the at least two users;
determining, based on the tracking information pertaining to the intentions of the at least two users, one or more expected locations of the at least two users' computing devices;
responsive to determining the one or more expected locations of the at least two users' computing devices, determining respective navigational guidance from each of the two users' computing devices to the one or more expected locations; and
providing, to each of the two users' computing devices, the respective navigational guidance to enable user interfaces of the two users' computing devices to display paths that merge at the one or more expected locations.

Clause 22. The computer-implemented method of any clause herein, wherein the tracking information pertaining to the intentions are determined from a calendar application, an electronic mail message, a text message, a voicemail, a search engine query, a web browser history, a location history of at least one of the two users' computing devices, or some combination thereof.

Clause 23. The computer-implemented method of any clause herein, wherein the determining, based on the tracking information pertaining to the intentions of the at least two users, the one or more expected locations of the at least two users' computing devices further comprises executing one or more trained machine learning models to predict, based on the tracking information, the one or more expected locations.

Clause 24. The computer-implemented method of any clause herein, further comprising determining, based on the tracking information pertaining to the intentions of the at least two users, a date and time of a meeting at the one or more expected locations.

Clause 25. The computer-implemented method of any clause herein, further comprising, based on the date and time of the meeting at the one or more expected locations, providing, to each of the two users' computing devices, the respective navigational guidance.

Clause 26. The computer-implemented method of any clause herein, further comprising:
determining whether one of the two users' computing devices does not arrive at the one or more expected locations; and
responsive to determining that the one of the two users' computing devices does not arrive at the one or more expected locations, performing a preventative action comprising transmitting a message, contacting emergency services, presenting a notification, or some combination thereof.

Clause 27. The computer-implemented method of any clause herein, further comprising, as a proximity of locations of the two users' computing devices changes, causing the user interfaces to modify the navigational guidance.

Clause 28. The computer-implemented method of any clause herein, further comprising:
determining whether a location of one of the two users' computing devices varies from a path by more than a threshold amount for more than a threshold period of time;

responsive to determining that the location of the one of the two users' computing devices varies from the path by more than the threshold amount for more than the threshold period of time, performing a preventative action comprising transmitting a message, alerting emergency services, presenting a notification, or some combination thereof.

Clause 29. A system comprising:
one or more memory devices storing instructions; and
one or more processing devices communicatively coupled to the one or more memory devices, wherein the one or more processing devices execute the instructions to:
   receive, from at least two users' computing devices, tracking information pertaining to intentions of the at least two users;
   determine, based on the tracking information pertaining to the intentions of the at least two users, one or more expected locations of the at least two users' computing devices;
   responsive to determining the one or more expected locations of the at least two users' computing devices, determine respective navigational guidance from each of the two users' computing devices to the one or more expected locations; and
   provide, to each of the two users' computing devices, the respective navigational guidance to enable user interfaces of the two users' computing devices to display paths that merge at the one or more expected locations.

Clause 30. The system of any clause herein, wherein the tracking information pertaining to the intentions are determined from a calendar application, an electronic mail message, a text message, a voicemail, a search engine query, a web browser history, a location history of at least one of the two users' computing devices, or some combination thereof.

Clause 31. The system of any clause herein, wherein the determining, based on the tracking information pertaining to the intentions of the at least two users, the one or more expected locations of the at least two users' computing devices further comprises executing one or more trained machine learning models to predict, based on the tracking information, the one or more expected locations.

Clause 32. The system of any clause herein, wherein the one or more processing devices determine, based on the tracking information pertaining to the intentions of the at least two users, a date and time of a meeting at the one or more expected locations.

Clause 33. The system of any clause herein, wherein, based on the date and time of the meeting at the one or more expected locations, the one or more processing devices provide, to each of the two users' computing devices, the respective navigational guidance.

Clause 34. The system of any clause herein, wherein the one or more processing devices:
determine whether one of the two users' computing devices does not arrive at the one or more expected locations; and
responsive to determining that the one of the two users' computing devices does not arrive at the one or more expected locations, performing a preventative action comprising transmitting a message, contact emergency services, presenting a notification, or some combination thereof.

Clause 35. The system of any clause herein, wherein, as a proximity of locations of the two users' computing devices changes, the one or more processing devices cause the user interfaces to modify the navigational guidance.

Clause 36. The system of any clause herein, wherein the one or more processing devices:
determine whether a location of one of the two users' computing devices varies from a path by more than a threshold amount for more than a threshold period of time;
responsive to determining that the location of the one of the two users' computing devices varies from the path by more than the threshold amount for more than the threshold period of time, perform a preventative action comprising transmitting a message, alerting emergency services, presenting a notification, or some combination thereof.

Clause 37. A system comprising:
one or more memory devices storing instructions; and
one or more processing devices communicatively coupled to the one or more memory devices, wherein the one or more processing devices execute the instructions to:
   receive, from at least two users' computing devices, tracking information pertaining to intentions of the at least two users;
   determine, based on the tracking information pertaining to the intentions of the at least two users, one or more expected locations of the at least two users' computing devices; responsive to determining the one or more expected locations of the at least two users' computing devices, determine respective navigational guidance from each of the two users' computing devices to the one or more expected locations; and
   provide, to each of the two users' computing devices, the respective navigational guidance to enable user interfaces of the two users' computing devices to display paths that merge at the one or more expected locations.

Clause 38. The system of any clause herein, wherein the tracking information pertaining to the intentions are determined from a calendar application, an electronic mail message, a text message, a voicemail, a search engine query, a web browser history, a location history of at least one of the two users' computing devices, or some combination thereof.

Clause 39. The system of any clause herein, wherein the determining, based on the tracking information pertaining to the intentions of the at least two users, the one or more expected locations of the at least two users' computing devices further comprises executing one or more trained machine learning models to predict, based on the tracking information, the one or more expected locations.

Clause 40. The system of any clause herein, wherein the one or more processing devices determine, based on the tracking information pertaining to the intentions of the at least two users, a date and time of a meeting at the one or more expected locations.

Clause 41. A computer-implemented method comprising:
receiving, from one or more sources, information pertaining to a plurality of users;
generating, based on the information, a plurality of scores associated with the plurality of users;
determining a subset of the plurality of users who are associated with a score that satisfies a threshold score;
providing, to a first computing device of a first user, one or more recommendations associated with the subset of the plurality of users;
receiving, from the first computing device of the first user, a request to meet a second user of the subset of the plurality of users;
receiving, from the first computing device of the first user and a second computing device of the second user, tracking information pertaining to locations of the first and second user; determining, based on the tracking information, the locations of the first and second computing devices;
responsive to determining the locations of the first and second computing devices, determining respective navigational guidance from each of the first and second computing devices to a meeting location; and
providing, to each of the first and second computing devices, the respective navigational guidance to enable user interfaces of the first and second computing devices to display paths that merge at the meeting location.

Clause 42. The computer-implemented method of any clause herein, wherein the one or more sources comprise a website, an application, a computing device, or some combination thereof.

Clause 43. The computer-implemented method of any clause herein, wherein one or more machine learning models are trained to generate, based on the information, the plurality of scores associated with the plurality of users.

Clause 44. The computer-implemented method of any clause herein, wherein the tracking information comprises vehicle information, electronic device identifier information pertaining to one or more electronic devices, facial recognition information, other biometric information, or some combination thereof.

Clause 45. The computer-implemented method of any clause herein, further comprising executing a trained machine learning model to recommend the meeting location, wherein based on inputs comprising user characteristics, user preferences, location characteristics, crime statistics related to locations, or some combination thereof, the trained machine learning model is trained.

Clause 46. The computer-implemented method of any clause herein, further comprising, as a proximity of locations of the first and second computing devices changes, causing the user interfaces to modify the navigational guidance.

Clause 47. The computer-implemented method of any clause herein, further comprising determining, using one or more machine learning models, a risk level of meeting at the meeting location.

Clause 48. A system comprising:
one or more memory devices storing instructions;
one or more processing devices communicatively coupled to the one or more memory devices, wherein the one or more processing devices execute the instructions to:
   receive, from one or more sources, information pertaining to a plurality of users; generate, based on the information, a plurality of scores associated with the plurality of users;
   determine a subset of the plurality of users who are associated with a score that satisfies a threshold score;
   provide, to a first computing device of a first user, one or more recommendations associated with the subset of the plurality of users;
   receive, from the first computing device of the first user, a request to meet a second user of the subset of the plurality of users;
   receive, from the first computing device of the first user and a second computing device of the second user, tracking information pertaining to locations of the first and second user;
   determine, based on the tracking information, the locations of the first and second computing devices;
   responsive to determining the locations of the first and second computing devices, determine respective navigational guidance from each of the first and second computing devices to a meeting location; and
   provide, to each of the first and second computing devices, the respective navigational guidance to enable user interfaces of the first and second computing devices to display paths that merge at the meeting location.

Clause 49. The system of any clause herein, wherein the one or more sources comprise a website, an application, a computing device, or some combination thereof.

Clause 50. The system of any clause herein, wherein one or more machine learning models are trained to generate, based on the information, the plurality of scores associated with the plurality of users.

Clause 51. The system of any clause herein, wherein the tracking information comprises vehicle information, electronic device identifier information pertaining to one or more electronic devices, facial recognition information, other biometric information, or some combination thereof.

Clause 52. The system of any clause herein, wherein the one or more processing devices execute a trained machine learning model to recommend the meeting location, wherein based on inputs comprising user characteristics, user preferences, location characteristics, crime statistics related to locations, or some combination thereof, the trained machine learning model is trained.

Clause 53. The system of any clause herein, wherein, as a proximity of locations of the first and second computing devices changes, the one or more processing devices cause the user interfaces to modify the navigational guidance.

Clause 54. The system of any clause herein, wherein the one or more processing devices determine, using one or more machine learning models, a risk level of meeting at the meeting location.

Clause 55. A tangible, non-transitory computer-readable medium storing instructions that, when executed, cause one or more processing devices to:
receive, from one or more sources, information pertaining to a plurality of users;
generate, based on the information, a plurality of scores associated with the plurality of users;
determine a subset of the plurality of users who are associated with a score that satisfies a threshold score;
provide, to a first computing device of a first user, one or more recommendations associated with the subset of the plurality of users;
receive, from the first computing device of the first user, a request to meet a second user of the subset of the plurality of users;
receive, from the first computing device of the first user and a second computing device of the second user, tracking information pertaining to locations of the first and second user;
determine, based on the tracking information, the locations of the first and second computing devices;
responsive to determining the locations of the first and second computing devices, determine respective navigational guidance from each of the first and second computing devices to a meeting location; and
provide, to each of the first and second computing devices, the respective navigational guidance to enable user interfaces of the first and second computing devices to display paths that merge at the meeting location.

Clause 56. The computer-readable medium of any clause herein, wherein the one or more sources comprise a website, an application, a computing device, or some combination thereof.

Clause 57. The computer-readable medium of any clause herein, wherein one or more machine learning models are trained to generate, based on the information, the plurality of scores associated with the plurality of users.

Clause 58. The computer-readable medium of any clause herein, wherein the tracking information comprises vehicle information, electronic device identifier information pertaining to one or more electronic devices, facial recognition information, other biometric information, or some combination thereof.

Clause 59. The computer-readable medium of any clause herein, wherein the one or more processing devices execute a trained machine learning model to recommend the meeting location, wherein based on inputs comprising user characteristics, user preferences, location characteristics, crime statistics related to locations, or some combination thereof, the trained machine learning model is trained.

Clause 60. The computer-readable medium of any clause herein, wherein, as a proximity of locations of the first and second computing devices changes, the one or more processing devices cause the user interfaces to modify the navigational guidance.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle.

What is claimed is:

1. A computer-implemented method comprising:
receiving, from at least two users' computing devices, tracking information pertaining to locations of the at least two users' computing devices;
determining, based on the tracking information, the locations of the at least two users' computing devices;
responsive to determining the locations of the at least two users' computing devices, providing to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface; and
as the proximity of the first and second locations changes, causing the first and second users' computing devices to present indications related to the proximity of the first and second locations.

2. The computer-implemented method of claim 1, further comprising, prior to receiving the tracking information:
(i) transmitting a request to the first user's computing device and the second user's computing device, wherein the request pertains to whether the first and second user desire to meet in-person, and
(ii) receiving an indication of an approved request from the first user's computing device and the second user's computing device for the at least two users to meet in-person.

3. The computer-implemented method of claim 2, wherein the request pertains to at least one of a date, a social interest or meetup group, a work event, a social event, a private event, a public event, or some combination thereof.

4. The computer-implemented method of claim 1, further comprising causing the first and second users' computing devices to present the indications on a respective graphical user interface displaying a map.

5. The computer-implemented method of claim 4, further comprising causing the first and second users' computing devices to present the indications as respective icons on the respective graphical user interfaces displaying the map.

6. The computer-implemented method of claim 1, further comprising executing a trained machine learning model to output a recommended meeting location, a recommended meeting date and time, or some combination thereof, wherein, based on inputs comprising user characteristics, user preferences, location characteristics, crime statistics related to locations, or some combination thereof, the trained machine learning model is trained.

7. The computer-implemented method of claim 1, further comprising executing a trained machine learning model to output a recommended user match, wherein the trained machine learning model is trained based on inputs comprising user characteristics, user preferences, dating history, or some combination thereof.

8. The computer-implemented method of claim 1, wherein the tracking information comprises vehicle information, electronic device identifier information pertaining to one or more electronic devices, facial recognition information, other biometric information, or some combination thereof.

9. The computer-implemented method of claim 1, wherein the tracking information is received based on a scheduled date and time.

10. The computer-implemented method of claim 1, further comprising transmitting, based on information about the first user, a warning message to the second user's computing device.

11. The computer-implemented method of claim 1, further comprising:
receiving, from one or more websites and/or applications, information pertaining to a first user of the two users, wherein the information pertains to a metric, a review, an image, a rating, a score, a comment, a message, or some combination thereof; and
providing, based on the information, a message pertaining to whether or not a second user of the two users should meet with the first user.

12. The computer-implemented method of claim 1, further comprising:
determining a meeting location for the at least two users' computing devices, an identity of at least one of the two users, or both;
based on the meeting location, the identity, or both, determining a risk level; and
based on the risk level, transmitting a message to one or both of the two users' computing devices, wherein the message pertains to whether or not the two users should meet.

13. A system comprising:
one or more memory devices storing instructions;
one or more processing devices communicatively coupled to the one or more memory devices, wherein the one or more processing devices execute the instructions to:
receive, from at least two users' computing devices, tracking information pertaining to locations of the at least two users' computing devices;
determine, based on the tracking information, the locations of the at least two users' computing devices;
responsive to determining the locations of the at least two users' computing devices, provide to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface; and
as the proximity of the first and second locations changes, cause the first and second users' computing devices to present indications related to the proximity of the first and second locations.

14. The system of claim 13, wherein, prior to receiving the tracking information, the one or more processing devices:
(i) transmit a request to the first user's computing device and the second user's computing device, wherein the request pertains to whether the first and second user desire to meet in-person, and
(ii) receive an indication of an approved request from the first user's computing device and the second user's computing device for the at least two users to meet in-person.

15. The system of claim 14, wherein the request pertains to at least one of a date, a social interest or meetup group, a work event, a social event, a private event, a public event, or some combination thereof.

16. The system of claim 13, wherein the one or more processing devices cause the first and second users' computing devices to present the indications on a respective graphical user interface displaying a map.

17. The system of claim 16, wherein the one or more processing devices cause the first and second users' computing devices to present the indications as respective icons on the respective graphical user interfaces displaying the map.

18. The system of claim 13, wherein the one or more processing devices execute a trained machine learning model to output a recommended meeting location, a recommended meeting date and time, or some combination thereof, wherein, based on inputs comprising user characteristics, user preferences, location characteristics, crime statistics related to locations, or some combination thereof, the trained machine learning model is trained.

19. The system of claim 13, wherein the one or more processing devices execute a trained machine learning model to output a recommended user match, wherein the trained machine learning model is trained based on inputs comprising user characteristics, user preferences, dating history, or some combination thereof.

20. A tangible, non-transitory computer-readable medium storing instructions that, when executed, cause one or more processing devices to:
receive, from at least two users' computing devices, tracking information pertaining to locations of the at least two users' computing devices;
determine, based on the tracking information, the locations of the at least two users' computing devices;
responsive to determining the locations of the at least two users' computing devices, provide to a second user's computing device a first location of a first user's computing device, wherein the second user's computing device is enabled to display the first location on a first user interface, and providing to the first user's computing device a second location of the second user's computing device, wherein the first user's computing device is enabled to display the second location on a second user interface; and
as the proximity of the first and second locations changes, cause the first and second users' computing devices to present indications related to the proximity of the first and second locations.
